(19) United States
(12) Patent Application Publication
(10) Pub. No.: US 2012/0108431 A1
(43) Pub. Date: May 3, 2012

(54) PLANT GROWTH REGULATOR ADDITIVE

(75) Inventors: Richard Williams, Colchester (GB); Peter Roose, Ghent (BE); Johan Josef De Saegher, Ghent (BE)

(73) Assignee: TAMINCO, NAAMLOZE VENNOOTSCHAP, Ghent (BE)

(21) Appl. No.: 13/263,646

(22) PCT Filed: Apr. 7, 2010
(86) PCT No.: PCT/IB10/00968

§ 371 Date: Dec. 30, 2011

(30) Foreign Application Priority Data
Apr. 7, 2009 (ET) 09447008.5

(51) Int. Cl. A01N 57/16; A01N 43/38; A01N 39/02; A01N 37/10; A01P 21/00; A01N 43/40; A01N 47/12; A01N 27/00; A01N 43/653; A01N 33/12; A01N 25/00; A01N 39/04

(52) U.S. Cl. 504/196; 504/358; 504/284; 504/323; 504/195; 504/321; 504/260; 504/300; 504/357; 504/318; 504/272; 504/345

(57) ABSTRACT

The present invention relates to a method and composition for improving the efficacy of a plant growth regulator by the use of, particularly but not exclusively, anthranilic acid in combination with an additional agrochemically acceptable additive.

### FIELD OF THE INVENTION

This invention relates to a method and composition for improving the efficacy of a plant growth regulator by the use of, particularly but not exclusively, anthranilic acid or acetaminophen, optionally in combination with each other, and optionally in combination with an agrochemically acceptable additive. The present invention also relates to a method and composition for improving the efficacy of a plant growth regulator by the use of, particularly but not exclusively, anthranilic acid and/or acetaminophen optionally in combination with an additional agrochemically acceptable additive.

### BACKGROUND OF THE INVENTION

The importance of plant growth regulators in controlling plant growth and development is well documented. The compounds are useful for altering a plant's life processes or structure in some beneficial way so as to enhance yield, improve quality or facilitate harvesting.

Given their importance in agriculture it will be appreciated that a need exists to provide methods and compositions which increase the benefits afforded by the use of plant growth regulators.

### SUMMARY OF THE INVENTION

The present invention relates to the novel use of anthranilic acid or its derivatives.

Anthranilic acid is used as an intermediate for production of dyes, pigments and saccharin. It and its esters are also used in preparing perfumes to imitate jasmine and orange, pharmaceuticals (loop diuretics such as furosemide) and UV-absorbers, as well as corrosion inhibitors for metals and mold inhibitors in soya sauce. Its usefulness as a part of a plant growth regulator package is surprising.

The present invention also relates to the use of acetaminophen or its derivatives. Acetaminophen is widely used as an over-the-counter analgesic and antipyretic. It will be appreciated that its efficacy as part of a plant growth regulator package is surprising.

### STATEMENTS OF THE INVENTION

The present invention is directed to the treatment of a plant with an effective amount of the compound anthranilic acid (also referred to as “AN”) or an effective salt, ester, or amide thereof including analogs of the AN and effective salts, ester and amides thereof in combination with an agrochemically acceptable additive to improve the effects of a plant growth regulator (also referred to as “PGR”).

According to one aspect of the present invention there is provided a composition comprising anthranilic acid or a derivative thereof and an agrochemically acceptable additive comprising at least one compound selected from a) glucose, hydrolysed starch, sucrose, fructose, glycerol, glyceraldehydes, erythrose, ribulose, xylulose or arabinose, monosaccharides including aldoses such as D-ribose, D-xylose, L-arabinose, D-glucose, D-mannose and D-galactose; ketoses such as D-ribulose and D-fructose; deoxyaldoses such as 2-Deoxy-D-ribose, L-fucose; acetylated amino sugars such as N-acteyl-D-glucosamine and N-acetyl-D-galactosamine; acidic monosaccharides such as D-glucuronic acid, L-iduronic acid and N-acetylneuraminic acid, sugar alcohols such as D-sorbitol and D-mannitol, disaccharides including maltose, lactose and sucrose, or an ester or glycoside or metabolic equivalent of such a carbohydrate; b) an organic acid of the Krebs tricarboxylic acid cycle or a metabolic precursor thereof; c) a vitamin or coenzyme, or a precursor thereof; d) a purine or pyrimidine nucleoside, nucleotide or metabolic precursor thereof; e) a naturally occurring fat or oil; or f) an amino acid, for use to improve the efficacy of a plant growth regulator. In other words the present invention is a composition for improving the effects of a PGR comprising, or consisting essentially of, or consisting of one or more of anthranilic acid or a derivative thereof and an agrochemically acceptable additive comprising at least one compound selected from a) glucose, hydrolysed starch, sucrose, fructose, glycerol, glyceraldehydes, erythrose, ribulose, xylulose or arabinose, monosaccharides including aldoses such as D-ribose, D-xylose, L-arabinose, D-glucose, D-mannose and D-galactose; ketoses such as D-ribulose and D-fructose; deoxyaldoses such as 2-Deoxy-D-ribose, L-fucose; acetylated amino sugars such as N-acteyl-D-glucosamine and N-acetyl-D-galactosamine; acidic monosaccharides such as D-glucuronic acid, L-iduronic acid and N-acetylneuraminic acid, sugar alcohols such as D-sorbitol and D-mannitol, disaccharides including maltose, lactose and sucrose, or an ester or glycoside or metabolic equivalent of such a carbohydrate; b) an organic acid of the Krebs tricarboxylic acid cycle or a metabolic precursor thereof; c) a vitamin or coenzyme, or a precursor thereof; d) a purine or pyrimidine nucleoside, nucleotide or metabolic precursor thereof; e) a naturally occurring fat or oil; or f) an amino acid.

We have found that the use of an anthranilic acid or a derivative thereof and an agrochemically acceptable additive as defined above may give rise to a synergistic effect in relation to enhancing the effects of a (additional) plant growth regulator.

By analog we include a compound that has a similar structure, i.e. same active moiety, and similar chemical properties e.g. for AN, is capable of effecting an improvement in PGR activity.

In one embodiment the derivative of AN or its analog is a salt, an ester, or an amide of the acid, or a conjugate of any of the foregoing.

In one embodiment the derivative compound used in the present invention is in the form of a conjugate, e.g. conjugated to a sugar, an alcohol, an amino acid, a peptide or a protein.

In one embodiment the analog of AN is a compound having the structure shown in FIG. 1.

For ease of reference we will refer to all of the above mentioned AN, analogs and derivatives thereof as “AN-related compounds”.

In one embodiment the agrochemically acceptable additive comprises at least one compound selected from c) a vitamin or coenzyme, or a precursor thereof; d) a purine or pyrimidine nucleoside, nucleotide or metabolic precursor thereof; or f) an amino acid.

According to a further aspect of the present invention there is provided a composition comprising anthranilic acid or a derivative thereof according to the present invention together with acetaminophen or an analog or derivative thereof for use to improve the efficacy of a plant growth regulator, optionally but preferably with an agrochemically acceptable additive as defined above.

We have found that a combination of an anthranilic acid or a derivative thereof according to the present invention together with acetaminophen or an analog or derivative thereof may give rise to a synergistic effect in relation to enhancing the effects of a (additional) plant growth regulator.

We have found that a combination of anthranilic acid or a derivative thereof according to the present invention together with acetaminophen or an analog or derivative thereof together with an agrochemically acceptable additive as defined above may give rise to a synergistic effect in relation to enhancing the effects of a (additional) plant growth regulator.

In one embodiment the acetaminophen derivative is one of the compounds set out in FIG. 3.

Preferably the present invention makes use of acetaminophen.

In a preferred embodiment the compositions of the present invention further comprise a plant growth regulator. It will be appreciated that the plant growth regulator should be different to the other components of the composition.

In a preferred embodiment, the plant growth regulator is other than a naturally occurring plant hormone.

In a preferred embodiment the plant growth regulator is other than an auxin, an auxin precursor, an auxin metabolite or a derivative of said auxin, auxin precursor or auxin metabolite.

If the plant growth regulator is selected from an auxin, an auxin precursor, an auxin metabolite or a derivative of said auxin, auxin precursor or auxin metabolite, then the plant growth regulator is not an anthranilic acid or derivative thereof according to the present invention.

In embodiments involving an auxin it may be an indolic auxin or a phenolic auxin.

In one embodiment the auxin derivative is an acid, a conjugate, a salt, an ester, or an amide of the auxin, or an alkyated or halogenated auxin.

In one embodiment the auxin is conjugated to a sugar, an alcohol, an amino acid, a peptide or a protein.

In one embodiment the auxin precursor is chorismate, phosphoribosyl anthraniliate, 1-(O-carboxyphenulamino)-1-deoxyribulose-5-phosphate, indole-3-glycerol-phosphate, indole, indole-3-acetic acid, tryptophan, tryptamine, N-hydroxy tryptamine, indole-3-acetaldoxime, 1-aci-nitro-2-indolylethane, indolic glucosinate, indole-3-acetonitrile (IAN), indole-3-acetaldehyde, indole-3-lactic acid, indole-3-pyruvic acid, or indole-3-ethanol.

The auxin may be a natural, such as is obtainable from seaweed and algae, or synthetic auxin.

In one embodiment the natural auxin is indole-3-acetic acid (IAA), 4-chloro-indole-3-acetic acid (4-Cl-IAA), phenylacetic acid (PAA), indole-3-butyric acid (IBA), indole-3-acetyl-1-O-β-D-glucose (IAAglc).

In one embodiment the conjugate of the natural auxin is IAA-Inositol, IAA-Inositol-arabinose, IAP1, an IAA-peptide, an IAA glycoprotein, an IAA-glucan, IAA-aspartate, IAA-glucose, IAA-1-O-glucose, IAA-myo-Inositol, IAA-4-O-glucose, IAA-6-O-glucose, IAA-Inositol-galactose, an IAA amide conjugate, or an IAA-amino acid conjugate.

In another embodiment the synthetic auxin is 1-naphthaleneacetic acid (NAA), 2,4-dichlorophenoxyacetic acid (2,4-D), 2-methoxy-3,6-dichlorobenzoic acid (dicamba), 4-amino-3,5,6-trichloropicolinic acid (tordon), 2,4,5-trichlorophenoxyacetic acid (2,4,5-T), 2,3,6-trichlorobenzoic acid, 4-chloro-2 methyl phenoxy acetic acid (MCPA) or N,N-dimethylethylthiocarbamate.

In another embodiment the metabolite is indole-3-lactic acid or indole-3-ethanol.

In another embodiment the plant growth regulator is abscisic acid or a derivative thereof, a cytokinin, ethylene or a gibberellin.

Non-limiting examples of plant growth regulators which may be useful include p-Chlorophenoxyacetic acid (4-CPA), 2-CPA, 2,4-Dichlorophenoxyacetic acid, 2,4-Dichlorophenoxyacetic acid Sodium salt, Indole-3-acetic acid Free acid (IAA), Indole-3-acetic acid Sodium salt, Indole-3-acetic acid methyl ester, Indole-3-acety-L-aspartic acid, Indole-3-butyric acid (IBA), Indole-3-butyric acid Potassium salt (K-IBA), alpha-Naphthaleneacetic acid Free acid (NAA), beta-Naphthoxyacetic acid Free acid (NOA), Phenylacetic acid (PAA), Picloram, 2,4,5-Trichlorophenoxyacetic acid (2,4,5-T), 2,3,5-Triiodobenzoic acid Free acid (TIBA), Adenine Free base, Adenine hemisulfate salt, 6-Benzylaminopurine (BA), 6-Benzylaminopurine Hydrochloride, N-Benzyl-9-(2-tetrahydropyranyl) adenine (BPA), N-(2-Chloro-4-pyridyl)N′-phenylurea (4-CPPU), 6-(gamma, gamma-Dimethylallylamino)purine (2iP), 1,3-Diphenylurea (DPU), Kinetin, Kinetin Hydrochloride, 1-Phenyl-3-(1,2,3-thiadiazol-5-yl) urea, trans-Zeatin Free base, Zeatin, trans-Zeatin Hydrochloride, trans-Zeatin riboside, (±)-cis,trans-Abscisic acid (ABA), Ancymidol, Chlorocholine chloride (CCC, chlormequat chloride+choline chloride (5C chlormequat), 3,6-Dichloro-o-anisic acid (Dicamba), Gibberellic acid (GA₃), Gibberellic acid Potassium salt (K-GA₃), Gibberellin A₄ Free acid (GA₄), (±)-jasmonic acid, Phloroglucinol, N-(Phosphonomethyl)glycine (Glyphosate), Succinic acid 2,2-dimethylhydrazide, trinexapac-ethyl and metconazole.

Preferably the plant growth regulator is other than a naturally occurring plant hormone.

In one embodiment the plant growth regulator is selected from antiauxins, such as: clofibric acid and 2,3,5-tri-iodobenzoic acid; auxins such as 4-CPA, 2,4-D, 2,4-DB, 2,4-DEP, dichlorprop, fenoprop, IAA, IBA, naphthaleneacetamide, α-naphthaleneacetic acid, 1-naphthol, naphthoxyacetic acid, potassium naphthenate, sodium naphthenate, 2,4,5-T; cytokinins such as 2iP, benzyladenine, kinetin, zeatin; defoliants such as calcium cyanamide, dimethipin, endothal, ethephon, merphos, metoxuron, pentachlorophenol, thidiazuron, tribufos; ethylene inhibitors such as aviglycine,1-methylcyclopropene; ethylene releasers such as ACC, etacelasil, ethephon, glyoxime; gibberellins such as gibberellins, gibberellic acid; growth inhibitors such as abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, mepiquat, piproctanyl, prohydrojasmon, propham, 2,3,5-tri-iodobenzoic acid; morphactins such as chlorfluren, chlorflurenol, dichlorflurenol, flurenol; growth retardants such as chlormequat, daminozide, flurprimidol, mefluidide, paclobutrazol tetcyclacis, uniconazole; growth stimulators such as brassinolide, forchlorfenuron, hymexazol; and unclassified plant growth regulators such as benzofluor, buminafos, carvone, ciobutide, clofencet, cloxyfonac, cyanamide, cyclanilide, cycloheximide, cyprosulfamide, epocholeone, ethychlozate, ethylene, fenridazon, heptopargil, holosulf, inabenfide, karetazan, lead arsenate, methasulfocarb, prohexadione, pydanon, sintofen, triapenthenol, trinexapac.

In one embodiment the compound or composition of the present invention is applied with an adjuvant.

According to yet another aspect of the present invention there is provided a method of improving the efficacy of a plant growth regulator comprising applying the composition of the present invention to a plant growth regulator.

According to a further aspect of the present invention there is provided a method of regulating plant growth comprising applying the composition of the present invention to a plant or its environs.

We describe a method for applying to plants an effective amount of an auxin-related compound in combination with simultaneous or sequential applications of acetaminophen or an analog or derivative thereof and/or a plant growth regulator to improve the effects of the plant growth regulator.

The present invention further relates to a method for applying to plants an effective amount of an auxin-related compound in combination with simultaneous or sequential applications of the agrochemically acceptable additive of the present invention and/or a plant growth regulator to improve the effects of the plant growth regulator.

Thus we describe a kit of parts in which at least some of the components of the composition of the invention may be in separate containers.

There is also described anthranilic acid or an analog or a derivative thereof for use in improving the effects of a PGR.

There is further described a composition comprising anthranilic acid or a derivative thereof according to the present invention together with acetaminophen or an analog or derivative thereof for use to improve the efficacy of a plant growth regulator.

There is further described acetaminophen or an analog or derivative thereof for use to improve the efficacy of a plant growth regulator.

### ADVANTAGES

We have found that the compositions of the present invention significantly improve plant growth manipulation when added to a wide range of growth regulators. Data presented show results for chlormequat chloride, trinexapac-ethyl and a triazole as examples of different classes of growth regulators, when applied to soybean, navy bean, wheat and barley, as examples of crops. Whilst not wishing to be bound by any theory it is believed that the compounds and compositions of the present invention improve the crop modifying effects of plant growth regulators by e.g. further suppressing apical dominance (e.g. increased number of large shoots/branches), increasing rooting, enhancing plant biomass and improving final yield. In e.g. wheat and barley, the dramatically increased rooting (e.g. root weight in g) of these compounds when added to growth regulators resulted in significant reduction in root lodging at harvest.

### BRIEF DESCRIPTION OF THE FIGURES

FIG. 1 shows structures of examples of analogs of anthranilic acid.

FIG. 2 shows structures of examples of naturally occurring auxins and conjugates.

FIG. 3 shows structures of examples of derivatives of acetaminophen.

FIG. 4 shows an overview of the reactions leading from chorismate to IAA and tryptophan.

FIG. 5 shows the structure of some synthetic auxins.

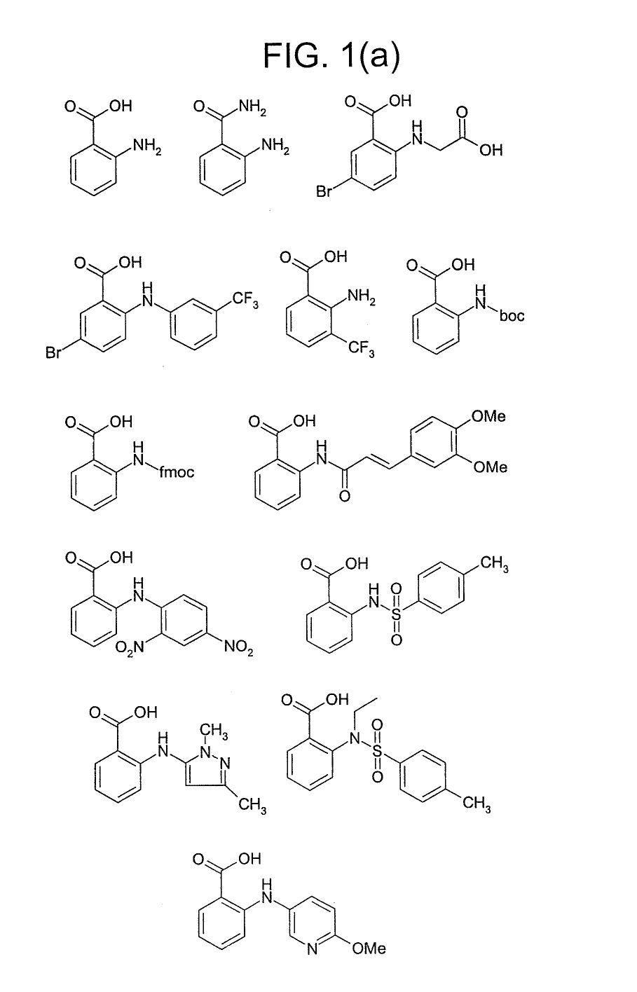

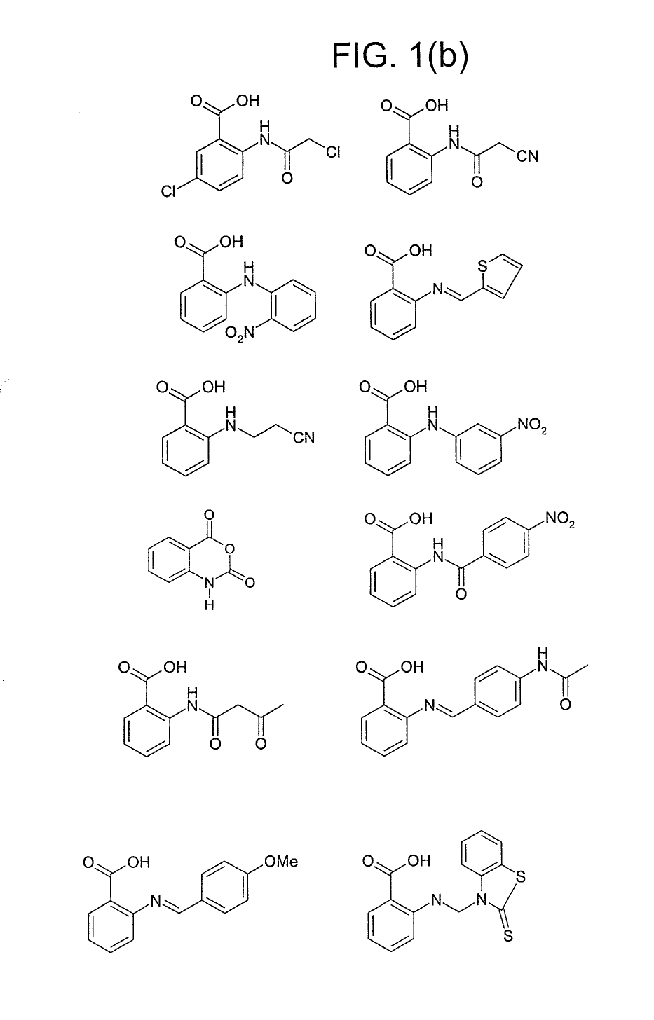

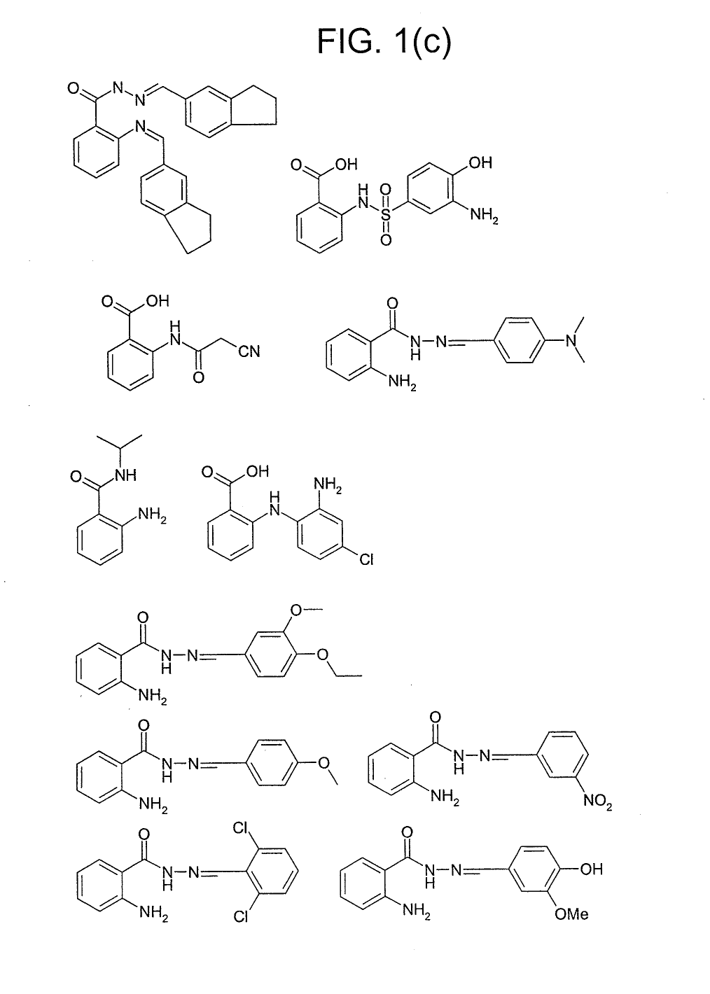

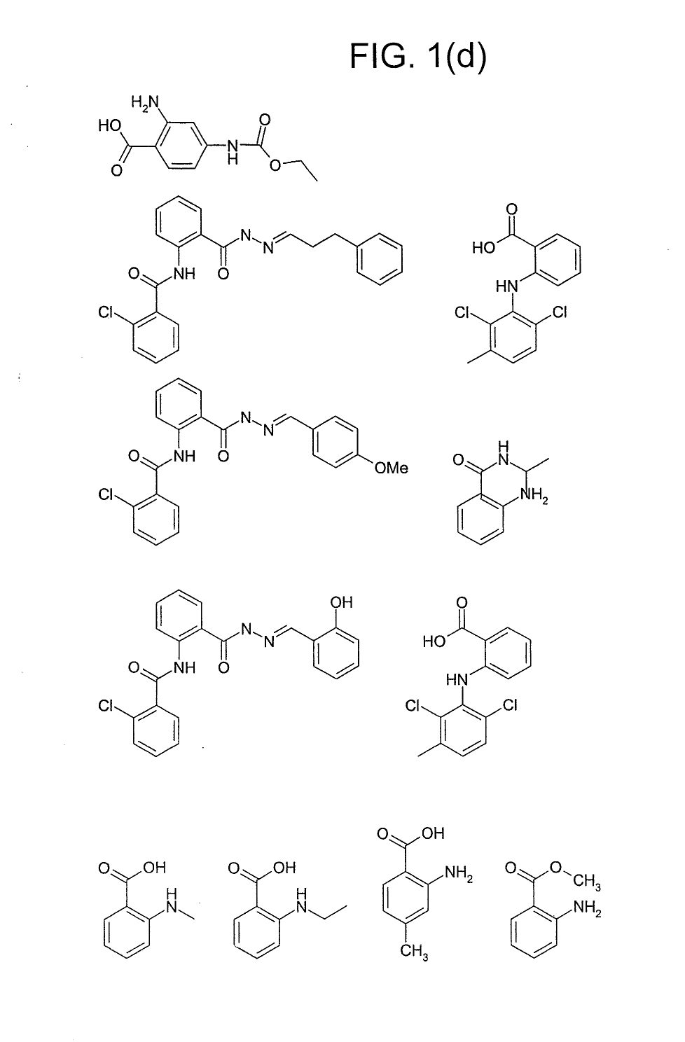

### DETAILED DESCRIPTION OF THE INVENTION

Various preferred features and embodiments of the present invention will now be described by way of non-limiting example.

The invention provides a process and a compound or a composition for improving PGR activity. The process of the invention includes applying an effective amount of a compound or composition to the plant.

By “effective amount” we include an amount of the compound or composition of the present invention which is sufficient to achieve the desired PGR improvement effect. The improvement effect refers to a class of plant responses which are induced by the application of a PGR. The induced responses are characterised by an enhancement in a desirable characteristic of the plant such as, for example, an increased total yield, e.g. as measured by the total weight of the desired plant organs, such as fruit, roots, tubers, leaves, seeds and the like.

The present invention relates to the use of anthranilic acid (AN):

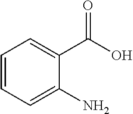

AN, also known as anthraniliate, has the CAS number 118-92-3.

We have described useful derivatives of AN above. Preferably such derivatives are water soluble. Representative salts include inorganic salts such as ammonium, lithium, sodium, potassium, magnesium and calcium salts and organic amine salts such as the triethanolamine, dimethylethanolamine and ethanolamine salts.

The present invention involves the use of acetaminophen in some embodiments.

Acetaminophen has the IUPAC name, N-(4-hydroxypheyl)acetamide and is commonly referred to as paracetamol. It has the CAS number 103-90-2.

Its formula is:

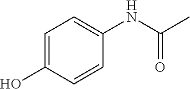

As described above, derivatives of acetaminophen are also useful in the present invention.

Aspects of the present invention also involve the use of an additive as defined as belonging to one or more of the following classes (a) to (f); although two or more such additives in the same or different classes may be used:

(a) glucose, hydrolysed starch, sucrose, fructose, glycerol, glyceraldehyde, erythrose, xylulose or arabinose, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or an ester or glycoside or metabolic equivalent of such a carbohydrate, which will normally be applied at 10 to 10,000 g/ha (grams per hectare). Without wishing to be bound by any theory the component may function as

(1) A source for the production of high energy bonds as in adenosine trisephosphate (ATP) production,

(2) For the formation of reduced nicotinamide adenine dinucleotide (NADH) and reduced nicotamide adenine dinucleotide phosphate (NADPH) and

(3) As precursors of amino acids and nucleotides;

(b) an organic acid of the Krebs Tricarboxylic Acid Cycle or a metabolic precursor thereof, (including citric, succinic, malic, pyruvic, acetic and fumaric acids), which will normally be applied at similar rates to and used for similar functions as the carbohydrate source;

(c) a vitamin or coenzyme, e.g. thiamine, riboflavin, pyridozine, pyridoxamine, pyridoxal, nicotinamide, folic acid, or a precursor thereof including nicotinic acid, which will normally be applied at 0.01 to 500 g/ha to stimulate metabolic processes dependent on enzymatic action;

(d) a purine or pyrimidine nucleoside, nucleotide or a metabolic precursor thereof, e.g. adenine, adenosine, thymine, thymidine, cytosine, guanine, guanosine, hypoxanthine, uracil, uridine or inosine, which will normally be applied at 1 to 500 g/ha to act as structural precursors for nucleic acid synthesis;

(e) a naturally occurring fat or oil including olive, soya, coconut and corn oils, which can be degraded by living organisms to fatty acids and which will normally be applied at 10 to 10,000 g/ha;

(f) an amino acid of a type that occurs naturally in plant proteins, e.g. glycine, alanine, valine, leucine, isoleucine, serine, threonine, cysteine, methionine, aspartic acid, glutamic, acid, glutamine, asparagine, lysine, hyroxylysine, arginine, histidine, phenylalanine, tyrosine, tryptophan, proline or hydroxyproline, which will normally be applied at 1 to 500 g/ha to act as structural units for newly formed proteins or by their degradation to function in a similar manner to fatty acids and carbohydrates.

The present invention aims to improve the effects of PGRs. PGRs are chemicals that regulate plant growth. PGRs shape the plant, affecting seed growth, time of flowering, the sex of flowers, senescence of leaves and fruits. They affect which tissues grow upward and which grow downward, leaf formation and stem growth, fruit development and ripening, plant longevity and even plant death.

It is generally accepted that there are five major classes of plant hormones, some of which are made up of many different chemicals that can vary in structure from one plant to the next. The chemicals are each grouped together into one of these classes based on their structural similarities and on their effects on plant physiology. Other plant hormones and growth regulators are not easily grouped into these classes, they exist naturally or are synthesized by humans or other organisms.

The five major classes of PGRs are:

### A. Auxins

An auxin is an organic substance that promotes cell elongation growth when applied in low concentrations to plant tissue segments in a bioassay. The most studied member of the auxin family is indole-3-acetic acid (IAA). In addition to IAA, there are several other naturally occurring auxins that have been described to date: IAA, IBA, PAA and 4-Cl-IAA. Naturally occurring auxins are found in plants as the free acid and in conjugated forms.

An auxin has been defined as a compound that gives rise to curvature in the grass coleoptile curvature (or growth) test. Such an assay is described by Fritz Went in 1926 and 1928. In this bioassay coleoptile tips of grass seedlings are placed on an agar plate containing the substance to be assayed. If an auxin response is present then the coleoptile bends in darkness and the angle of curvature can be measured. Went's results indicated that the curvatures of stems were proportional to the amount of growth substance in the agar. This test is also called the avena curvature test. Other functional tests which can be employed to determine auxin activity include the ability to cause rooting in stem cuttings and the ability to promote cell division in tissue or cell culture.

A review of auxins, their synthesis and metabolism can be found in e.g. Normanly, Slovin and Cohen in “Plant Hormones, Biosynthesis, Signal Transduction and Action!”, Ed Peter J. Davies, [2004] Chapter “B1. Auxin Biosynthesis and Metabolism” pages 36-62.

In addition to indolic auxins, various phenolic auxins have auxin activity.

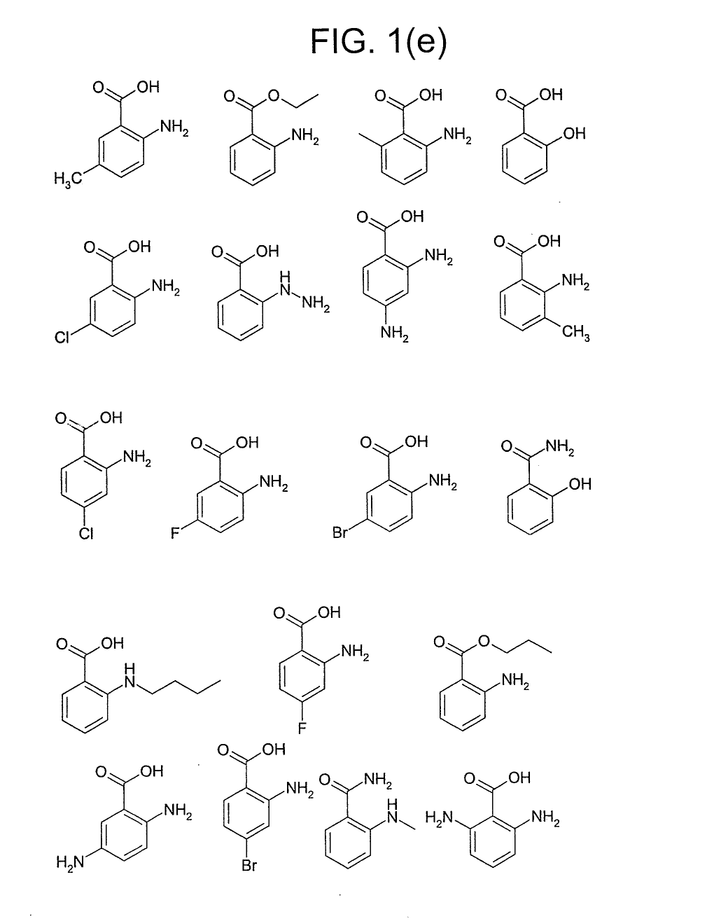

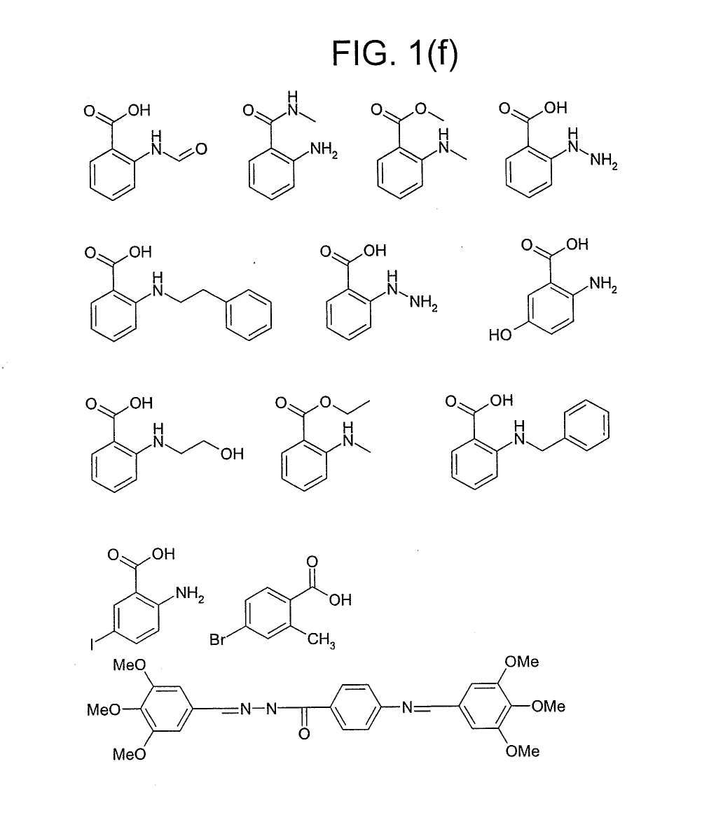

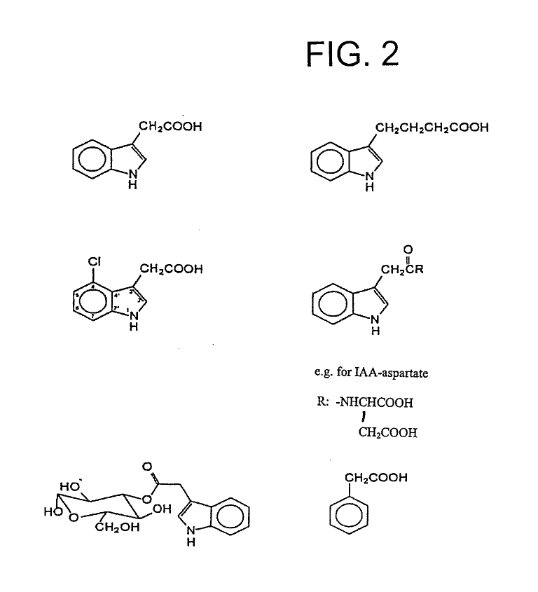

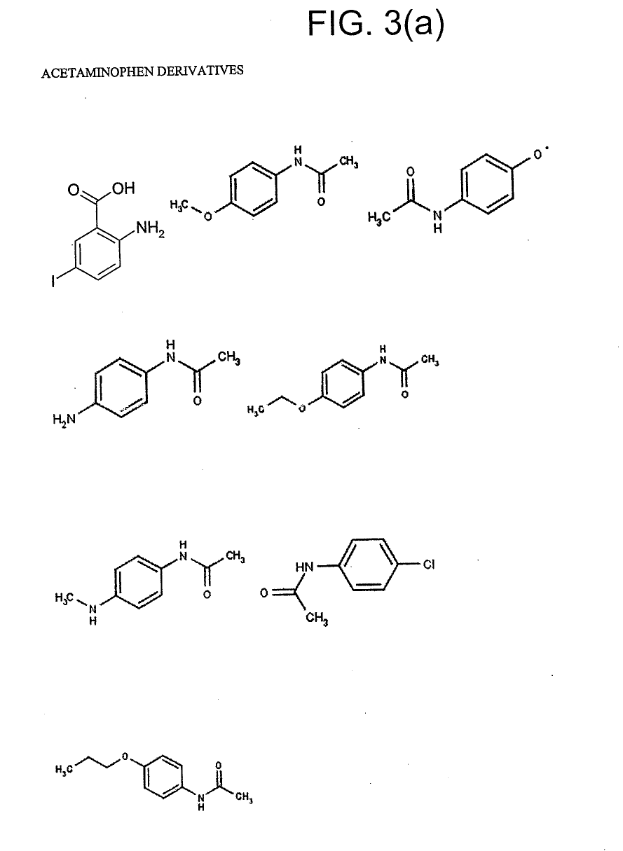

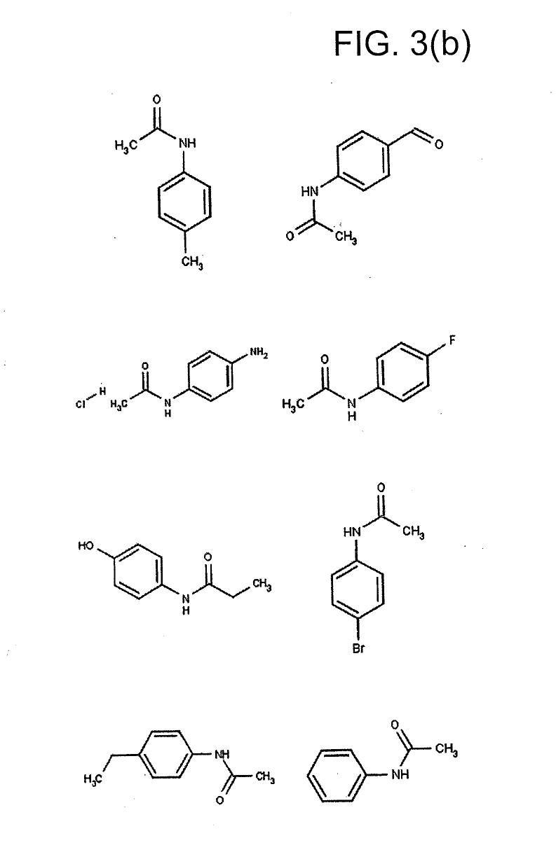

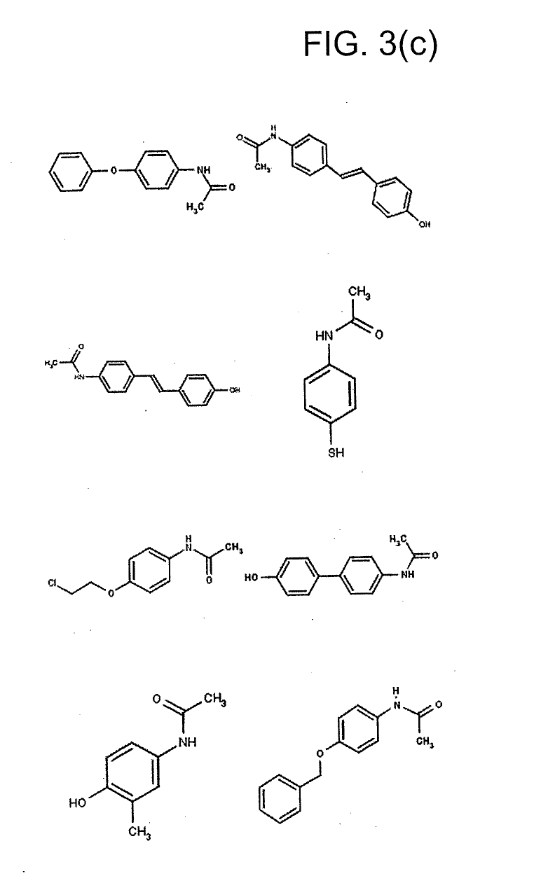

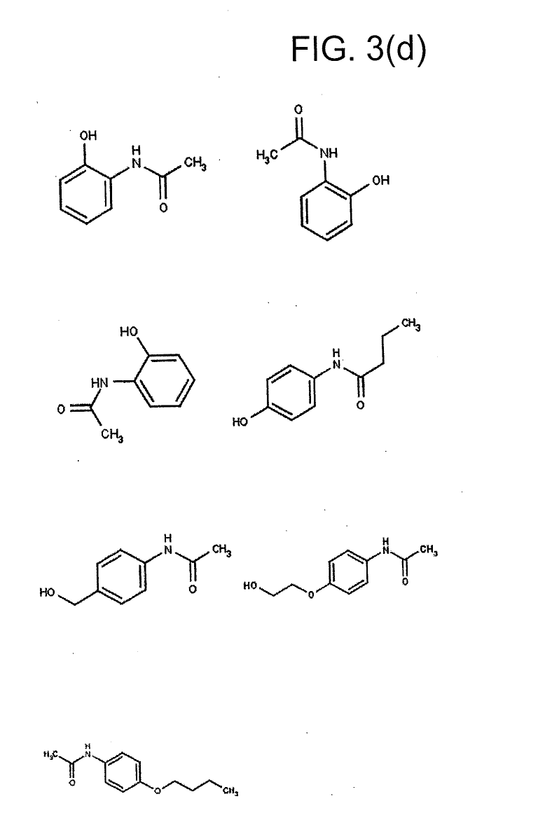

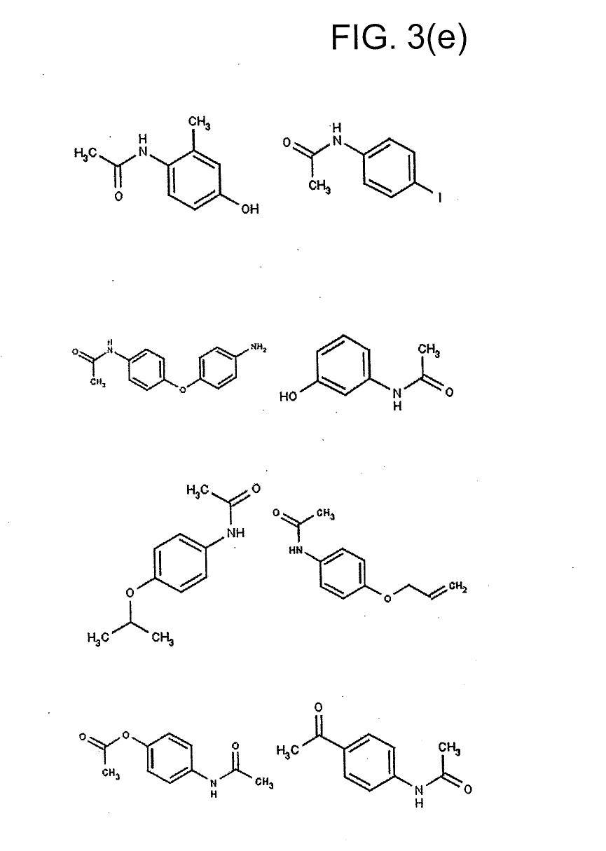

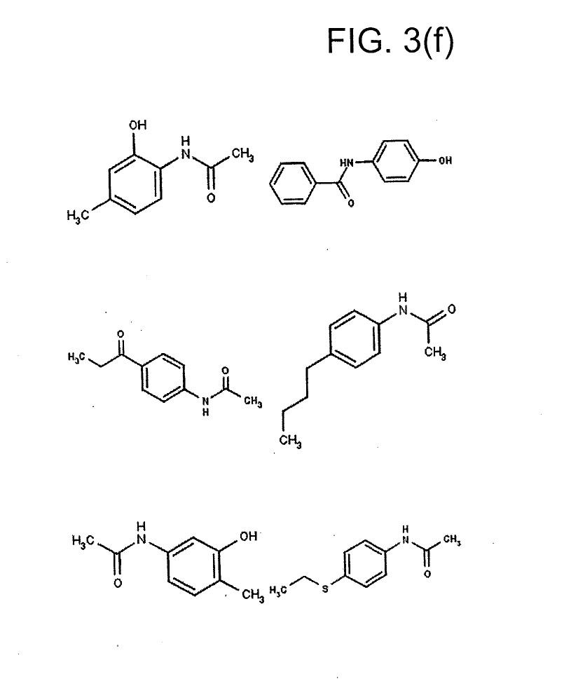

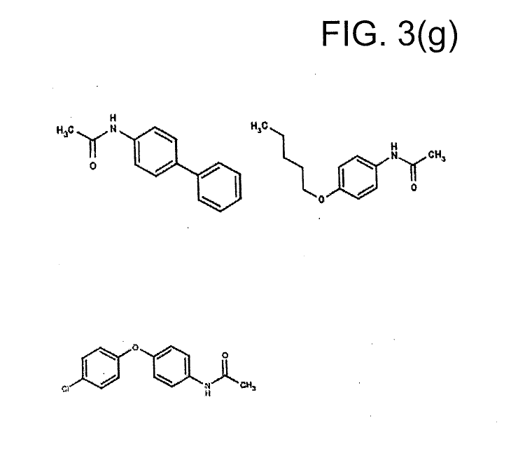

Some examples of naturally occurring auxins and some examples of the lower molecular weight conjugates which may be used in the present invention are shown in FIG. 2.

The present invention may also make use of conjugates. It is believed that plants use conjugates for storage purposes and/or to regulate the amount of free auxin available in the plant. IAA is primarily conjugated to the amino acid aspartate.

Related low molecular weight conjugates, such as IAA-Inos, IAA-Inos-arabinose and conjugates with other amino acids, and higher molecular weight conjugates, such as the IAA protein IAP1, IAA-peptides, IAA glycoprotein and IAA-glucans, have also been isolated from plants.

IAA and its precursors undergo metabolic conversions to indole-3-lactic acid, indole-3-ethanol and IBA. IBA has been found to occur naturally in plants; although some references refer to it as a synthetic auxin. Some commentators refer to it as an auxin per se and other as a precursor to IAA.

One general class of conjugated forms consists of those linked through carbon-oxygen-carbon bridges. These compounds have been referred to generically as “ester-linked”, although some 1-O sugar conjugates such as 1-O-IAA-Gluc are actually linked by acyl alkyl acetal bonds. Typical ester-linked moieties include 6-O-IAGluc, IAA-Inos, IAA-glycoproteins, IAA-glucans and simple methyl and ethyl esters. The other type of conjugates present in plants are linked through carbon-nitrogen-carbon amide bonds (referred to as “amide-linked”), as in the IAA-amino acid and protein and peptide conjugates (see FIG. 2).

Biochemical pathways that result in IAA production within a plant tissue include: (A) de novo synthesis, whether from tryptophan [referred to as Trp-dependent (Trp-D) IAA synthesis], or from indolic precursors of Trp [referred to as Trp-independent (Trp-I) IAA synthesis, since these pathways bypass Trp]; (B) hydrolysis of both amide- and ester-linked IAA conjugates; (C) transport from one site in the plant to another site; and (D) conversion of IBA to IAA. IAA turnover mechanisms include: (E) oxidative catabolism; (F) conjugate synthesis; (G) transport away from a given site; and (H) conversion of IAA to IBA. The present invention makes use of such precursors and metabolites along this pathway. The present invention does not make use of inactive metabolites, such as arise from catabolism of the auxin.

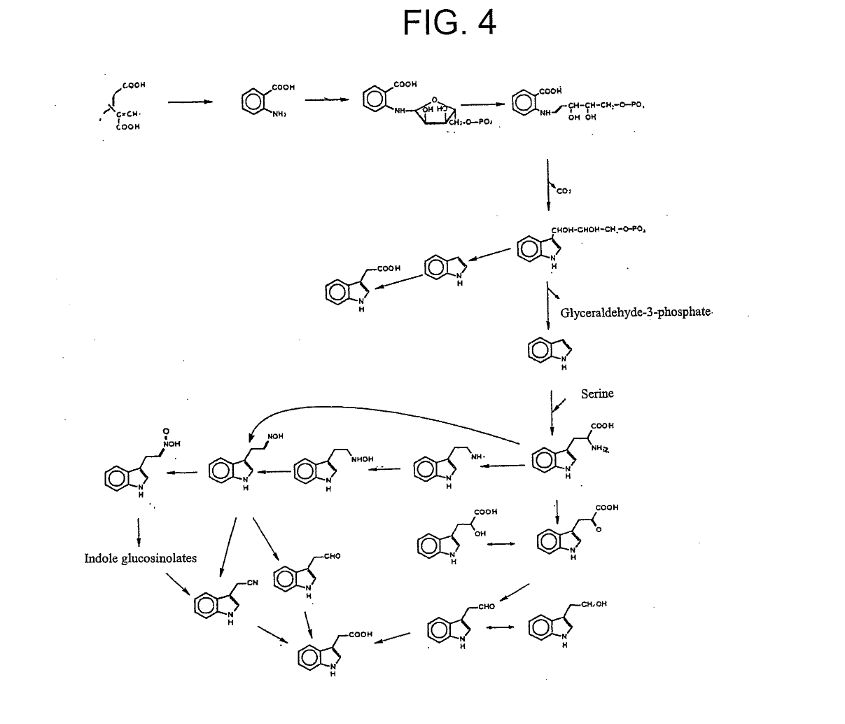

Normally the present invention makes use of the tryptophan-dependent pathway. A summary of the reactions leading from chorismate—the first committed step of indolic metabolism—to IAA and tryptophan is shown in FIG. 4.

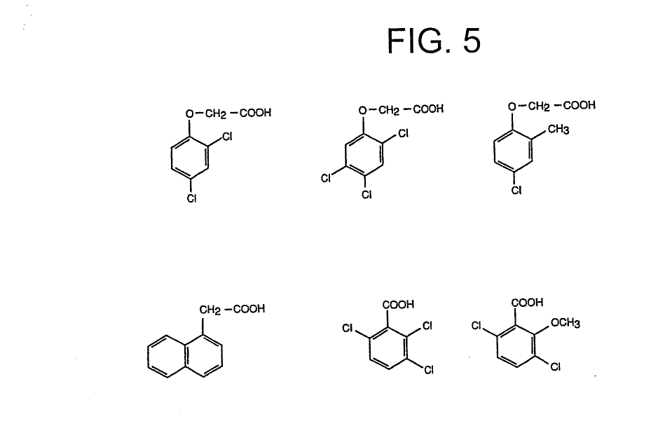

The present invention also encompasses the use of synthetic auxins. Some examples of synthetic auxins are shown in FIG. 5.

A comparison of the compounds that possess auxin activity reveals that at neutral pH they all have a strong negative charge on the carboxyl group of the side chain that is separated from a weaker positive charge on the ring structure by a distance of about 0.5 nm. It has been proposed that an indole is not essential for activity, but that it can be an aromatic or fused aromatic ring of a similar size. A model has been proposed as being a planar aromatic ring-binding platform, a carboxylic acid-binding site and a hydrophobic transition region that separates the two binding sites.

### B. Abscisic Acid

Abscisic acid is a single compound unlike the auxins, gibberellins, and cytokinins.

### C. Cytokinins

There are two types of cytokinins: adenine-type cytokinins represented by kinetin, zeatin and 6-benzylaminopurine, as well as phenylurea-type cytokinins like diphenylurea or thidiazuron (TDZ). All types of cytokinins, such as kinetin, can be used in the present invention, including those obtainable from seaweed and algae.

### D. Ethylene

Ethylene is a gas that forms from the breakdown of methionine, which is in all cells. Ethylene has been found to affect fruit-ripening.

### E. Gibberellins

Unlike the classification of auxins which are classified on the basis of function, gibberellins are classified on the basis of structure as well as function. All gibberellins are derived from the ent-gibberellane skeleton. The gibberellins are named GA₁ . . . GAₙ in order of discovery. Gibberellic acid, which was the first gibberellin to be structurally characterised, is GA₃. There are currently 136 GAs identified from plants, fungi and bacteria.

Examples of PGRs to which the present invention may usefully be applied include: p-Chlorophenoxyacetic acid (4-CPA), 2-CPA, 2,4-Dichlorophenoxyacetic acid, 2,4-Dichlorophenoxyacetic acid Sodium salt, Indole-3-acetic acid Free acid (IAA), Indole-3-acetic acid Sodium salt, Indole-3-acetic acid methyl ester, Indole-3-acety-L-aspartic acid, Indole-3-butyric acid (IBA), Indole-3-butyric acid Potassium salt (K-IBA), alpha-Naphthaleneacetic acid Free acid (NAA), beta-Naphthoxyacetic acid Free acid (NOA), Phenylacetic acid (PAA), Picloram, 2,4,5-Trichlorophenoxyacetic acid (2,4,5-T), 2,3,5-Triiodobenzoic acid Free acid (TIBA), Adenine Free base, Adenine hemisulfate salt, 6-Benzylaminopurine (BA), 6-Benzylaminopurine Hydrochloride, N-Benzyl-9-(2-tetrahydropyranyl) adenine (BPA), N-(2-Chloro-4-pyridyl)N′-phenylurea (4-CPPU), 6-(gamma, gamma-Dimethylallylamino)purine (2iP), 1,3-Diphenylurea (DPU), Kinetin, Kinetin Hydrochloride, 1-Phenyl-3-(1,2,3-thiadiazol-5-yl) urea, trans-Zeatin Free base, Zeatin, trans-Zeatin Hydrochloride, trans-Zeatin riboside, (±)-cis,trans-Abscisic acid (ABA), Ancymidol, Chlorocholine chloride (CCC), chlormequat chloride+choline chloride (5C chlormequat), 3,6-Dichloro-o-anisic acid (Dicamba), Gibberellic acid (GA₃), Gibberellic acid Potassium salt (K-GA₃), Gibberellin A₄ Free acid (GA₄), (±)-jasmonic acid, Phloroglucinol, N-(Phosphonomethyl)glycine (Glyphosate), Succinic acid 2,2-dimethylhydrazide, trinexapac-ethyl or metconazole.

Further examples of PGRs to which the present invention may usefully be applied include:

Antiauxins, such as: clofibric acid and 2,3,5-tri-iodobenzoic acid;

Auxins (not preferred) such as 4-CPA, 2,4-D, 2,4-DB, 2,4-DEP, dichlorprop, fenoprop, IAA, IBA, naphthaleneacetamide, α-naphthaleneacetic acid, 1-naphthol, naphthoxyacetic acid, potassium naphthenate, sodium naphthenate, 2,4,5-T; Cytokinins such as 2iP, benzyladenine, kinetin, zeatin; defoliants such as calcium cyanamide, dimethipin, endothal, ethephon, merphos, metoxuron, pentachlorophenol, thidiazuron, tribufos;

Ethylene inhibitors such as aviglycine,1-methylcyclopropene; ethylene releasers such as ACC, etacelasil, ethephon, glyoxime;

Gibberellins such as gibberellins, gibberellic acid;

Growth inhibitors such as abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, mepiquat chloride, piproctanyl, prohydrojasmon, propham, 2,3,5-tri-iodobenzoic acid;

Morphactins such as chlorfluren, chlorflurenol, dichlorflurenol, flurenol; growth retardants such as chlormequat, daminozide, flurprimidol, mefluidide, paclobutrazol tetcyclacis, uniconazole; growth stimulators such as brassinolide, forchlorfenuron, hymexazol; and

Unclassified plant growth regulators such as benzofluor, buminafos, carvone, ciobutide, clofencet, cloxyfonac, cyanamide, cyclanilide, cycloheximide, cyprosulfamide, epocholeone, ethychlozate, ethylene, fenridazon, heptopargil, holosulf, inabenfide, karetazan, lead arsenate, methasulfocarb, prohexadione, pydanon, sintofen, triapenthenol, trinexapac.

Other ingredients such as adjuvants may be added to the thinning solution. The adjuvants can facilitate spreading and efficacy, and improve the adhesion properties of the composition, and generally include oils, antifoaming agents and surfactants. Such components which are useful in the present invention include, but are not limited to: terpene, Brij family (polyoxyethylene fatty alcohol ether) from Uniqema (Castle, Del.); surfactant in Tween family (Polyoxyethylene sorbitan esters) from Uniqema (Castle, Del.); Silwet family (Organosilicone) from Union Carbide (Lisle, Ill.); Triton family (Octylphenol ethoxylate) from The Dow Chemical Company (Midland, Mich.); Tomadol family (ethoxylated linear alcohol) from Tomah3 Products, Inc. (Milton, Wis.); Myrj family (Polyoxyethylene (POE) fatty acid esters) from Uniqema (Castle, Del.); Span family (Sorbitan ester) from Uniqema (Castle, Del.); and Trylox family (Ethoxylated Sorbitol and Ethoxylated Sorbitol Esters) from Cognis Corporation (Cincinnati, Ohio) as well as commercial surfactant Latron B-1956 (77.0% modified phthalic/glycerol alkyl resin and 23.0% Butyl alcohol) from Rohm & Haas (Philadelphia, Pa.); Caspil (Blend of Polyether-polymethylsiloxanecopolymer and nonionic surfactant) from Aquatrols (Paulsboro, N.J.); Agral 90 (Nonyl phenol ethoxylate) from Norac Concept, Inc. (Orleans, Ontario, Canada); Kinetic (99.00% Proprietary blend of polyalkyleneoxide modified polydimethylsiloxane and nonionic surfactants) from Setre Chemical Company (Memphis, Tenn.); and Regulaid (90.6% 2-butoxyethanol, poloxalene, monopropylene glycol) from KALO, Inc. (Overland Park, Kans.).

When the final solution is to be applied to plants which, because of their hairy or waxy surface, may be difficult to wet, it may be particularly advantageous to include such other additives, commonly known in the agrochemical industry, such as surfactants, wetting agents, spreaders and stickers. (Examples of wetting agents include silicone surfactants, nonionic surfactants such as alkyl ethoxylates, anionic surfactants such as phosphate ester salts and amphoteric or cationic surfactants such as fatty acid amido alkyl betaines).

The compounds of the invention may be the sole active ingredient of the composition or they may be admixed with one or more additional active ingredients such as nematicides, insecticides, synergists, herbicides, fungicides, fertilisers or chemical thinners where appropriate.

In a particularly preferred embodiment, the one or more compounds of the invention are administered in combination optionally with one or more active agents. In such cases, the compounds of the invention may be administered consecutively, simultaneously or sequentially with each other or the one or more active agents. The major advantages of combining the compounds are that it may promote additive or possible synergistic effects through e.g. biochemical interactions. Beneficial combinations may be suggested by studying the activity of the test compounds. This procedure can also be used to determine the order of administration of the agents, i.e. before, simultaneously or after delivery.

In order to apply the composition to the plant or environs of the plant, the composition may be used as a concentrate or more usually is formulated into a composition which includes an effective amount of the composition of the present invention together with a suitable inert diluent, carrier material and/or surface active agent. Preferably the composition is in the form of an aqueous solution which may be prepared from the concentrate. By effective amount we mean that the composition (and/or its individual components) provides an improved effect.

The applied concentration of chemical can vary widely depending on the water volume applied to plants as well as other factors such as plant age and size, and plant sensitivity to the product. Typical rates of AN-related compounds would be 1-10 g/ha (preferably and as used in these trials, 1 g per hectare was applied), typical rates of acetaminophen or its derivatives would be 1-10 g/ha (preferably and as used in these trials, 3 g per hectare was applied). Typical rates of the agrochemically acceptable additive of the present invention would be 1-10 g/ha (preferably and as used in these trials, less than 3 g per hectare was applied). The rate of other components such as spreaders and stickers can be 50-200 ml per ha.

The rate and timing of application will depend on a number of factors known to those skilled in the art, such as the type of species etc. A second or further application(s) can be made as appropriate. The timings between each application may be in the region of 5 days or more.

The compositions of the present invention can be applied to the soil, plant, seed, or other area to be protected. Preferably the present invention is applied to the foliage of plants. The composition may be applied in the form of dusting powders, wettable powders, granules (slow or fast release), water dispersible granules, emulsion or suspension concentrates, liquid solutions, emulsions, seed dressings, or controlled release formulations such as microencapsulated granules or suspensions, soil drench, irrigation component, or preferably a foliar spray.

Dusting powders are formulated by mixing the active ingredient with one or more finely divided solid carriers and/or diluents, for example natural clays, kaolin, pyrophyllite, bentonite, alumina, montmorillonite, kieselguhr, chalk, diatomaceous earths, calcium phosphates, calcium and magnesium carbonates, sulfur, lime, flours, talc and other organic and inorganic solid carriers.

Granules are formed either by absorbing the active ingredient in a porous granular material for example pumice, attapulgite clays, fuller's earth, kieselguhr, diatomaceous earths, ground corn cobs, and the like, or on to hard core materials such as sands, silicates, mineral carbonates, sulfates, phosphates, or the like. Agents which are commonly used to aid in impregnation, binding or coating the solid carriers include aliphatic and aromatic petroleum solvents, alcohols, polyvinyl acetates, polyvinyl alcohols, ethers, ketones, esters, dextrins, sugars and vegetable oils, with the active ingredient. Other additives may also be included, such as emulsifying agents, wetting agents or dispersing agents.

Microencapsulated formulations (microcapsule suspensions CS) or other controlled release formulations may also be used, particularly for slow release over a period of time, and for seed treatment.

Alternatively and preferred the compositions may be in the form of liquid preparations to be used as dips, irrigation additives or sprays, which are generally aqueous dispersions or emulsions of the active ingredient in the presence of one or more known wetting agents, dispersing agents or emulsifying agents (surface active agents). The compositions which are to be used in the form of aqueous dispersions or emulsions are generally supplied in the form of an emulsifiable concentrate (EC) or a suspension concentrate (SC) containing a high proportion of the active ingredient or ingredients. An EC is an homogeneous liquid composition, usually containing the active ingredient dissolved in a substantially non-volatile organic solvent. An SC is a fine particle size dispersion of solid active ingredient in water. To apply the concentrates they are diluted in water and are usually applied by means of a spray to the area to be treated.

Suitable liquid solvents for ECs include methyl ketone, methyl isobutyl ketone, cyclohexanone, xylenes, toluene, chlorobenzene, paraffins, kerosene, white oil, alcohols (for example, butanol), methylnaphthalene, trimethylbenzene, trichloroethylene, N-methyl-2-pyrrolidone and tetrahydrofurfuryl alcohol (THFA).

These concentrates are often required to withstand storage for prolonged periods and after such storage, to be capable of dilution with water to form aqueous preparations which remain homogeneous for a sufficient time to enable them to be applied by conventional spray equipment. The concentrates may contain 1-85% by weight of the active ingredient or ingredients. When diluted to form aqueous preparations such preparations may contain varying amounts of the active ingredient depending upon the purpose for which they are to be used.

The composition may also be formulated as powders (dry seed treatment DS or water dispersible powder WS) or liquids (flowable concentrate FS, liquid seed treatment LS), or microcapsule suspensions CS for use in seed treatments. The formulations can be applied to the seed by standard techniques and through conventional seed treaters. In use the compositions are applied to the plants, to the locus of the plants, by any of the known means of applying fertiliser compositions, for example, by dusting, spraying, or incorporation of granules.

As indicated above, the fertilisers produced according to this present invention are usually applied to the foliage of plants but may also be applied to the soil or added to the irrigation water.

The present invention is useful in relation to fruit crops. The crops can include inter alia trees, bushes, and vines.

The present invention can be used on the following non-limiting plants:

Almond (Prunus dulcis), Apple (Malus domestica), Apricot (Prunus armeniaca), Avocado (Persea americana), Banana, Plantain (Musa spp.), Blackberries (Rubus spp), Blueberries (Vaccinium spp), Cacao or cocoa (Theobroma cacao), Cashew (Anacardium occidentale), Cherries (Prunus cerasus, P. avium), Chestnuts (Castanea spp.), Coconut (Cocos nucifera), Coffee (Coffea arabica, C. canephora), Cranberry (Vaccinium macrocarpon), Currants (Ribes spp), Date (Phoenix dactylifera), Fig (Ficus carica), Gooseberry (Ribes grossularia; R. hirtellum), Grapefruit (Citrus paradisi), Grapes (Vitis vinifera, other Vitis spp), Guava (Psidium guajava & related spp), Hazelnut or filbert (Corylus avellana), Juneberry (Amelanchier alnifolia), Kiwifruit (Actinidia deliciosa), Kumquat (Fortunella spp), Lemon (Citrus limon), Lime (Citrus aurantifolia), Loquat (Eriobotrya japonica), Macadamia (Macadamia integrifolia), Mango (Mangifera indica), Mayhaw (Crataegus spp.), Oil Palm (Elaeis guineensis), Olive (Olea europaea), Orange (Citrus sinensis), Papaya (Carica papaya), Peach (Prunus persica), Pears (Pyrus communis, P. pyrifolia), Pecan (Carya illinoensis), Pineapple (Ananas comosus), Pistachio (Pistacia vera), Plums (Prunus domestica, P. salicina), Pomegranate (Punica granatum), Quince (Cyclonia oblonga), Raspberries (Rubus idaeus, R. occidentalis), Strawberry (Fragaria X ananassa), Tangerine (Citrus reticulata), Walnut (Juglans regia), Chrysanthemum and Rhododendron such as Azalea (Azaleastrum).

The present invention can also be used on pre-harvest plants and post-harvest crops such as:

Tomatoes, squash, pumpkin, beans, broccoli, green beans, asparagus, peas, corn, carrots, spinach, cauliflower, lima beans, broad beans, french beans, runner beans, navy beans, kidney beans, lentils, cabbage, onions, courgettes, aubergines, sweet basil, leeks, artichokes, lettuce, cassava leaves, tomatoes, cucumbers and gherkins, marrows, gourds, squashes, chillies and peppers, green onions, dry onions, red onions, shallots, garlic, chives, other alliaceous vegetables, okra, mushrooms, watermelons, cantaloupe melons, other melons, bamboo shoots, beets, chards, capers, cardoons, celery, chervil, cress, fennel, horseradish, marjoram, oyster plant, parsley, parsnips, potato, radish, rhubarb, rutabaga, savory, scorzonera, sorrel, sprouts, swede, turnip, watercress and other vegetables.

The present invention can also be used on pre-harvest plants and post-harvest crops such as:

Maize, wheat, rye, oat, triticale, rice, barley, soybean, peanut, cotton, oilseed rape, sugar cane, bamboo, millet, sesame, jute, canola, coconut, manihot, sunflower, tobacco, ground nuts, peanuts, sorghum, oil palm, roses, hemp, flax, lucerne, alfalfa, tea and perennial grass

The following mixtures of the compound or composition of the present invention are particularly mentioned:

1. The addition of Anthranilic Acid (AN).

2. The addition of Acetaminophen (AC) to Anthranilic Acid (AN).

3. The addition of an additive (ADD) to AN.

4. The addition of ADD to AC.

5. The addition of ADD to AN+AC.

Such combination of the present invention may give rise to additive or synergistic effects.

The additive may be one set out as classes (a) to (f) above.

When the additive is selected from class (a) it is preferably one or more of glucose, sucrose, fructose or glycerol.

When the additive is selected from class (b) it is preferably one or more of citric or succinic acid.

When the additive is selected from class (c) it is preferably one or more of thiamine, riboflavin, pyridoxine, nicotinamide, folic acid, ascorbic acid, biotin or vitamin B12.

When the additive is selected from class (d) it is preferably adenine, adenosine and thymine.

When the additive is selected from class (e) it is preferably a corn oil.

When the additive is selected from an amino acid is it preferably one of more of glycine, alanine, valine, leucine, threonine, cysteine, methionine, glutamine, asparagine or lysine.

The following Examples further illustrate, but do not limit, the invention.

POL: polymer additive

ADD Example: at least one from class (f) each at <3 g/l, plus at least one from class (c).

### Benefits to Plant Growth Regultors:

### Statistical Analyses for Tables 1, 2 and 3:

TABLE 1
(Soybean):

| | | Pod- | | |
|---|---|---|---|---|
| | Rooting (0-9) + | Bearing | Biomass (0-9) + | Seed Yield |
| | 28 Days | Branches | 28 Days | at Harvest |
| LSD (5%) | 0.34 | 0.25 | 0.36 | 2.34 |
| Treatment | | | | |
| Means | | | | |

TABLE 2
(Navy Bean):

| | | Pod- | | |
|---|---|---|---|---|
| | Rooting (0-9) + | Bearing | Biomass (0-9) + | Seed Yield |
| | 28 Days | Branches | 28 days | at Harvest |
| LSD (5%) | 0.35 | 0.29 | 0.38 | 2.23 |
| Treatment | | | | |
| Means | | | | |

TABLE 3
(Winter Wheat):

| | Rooting (0-9) + | Total Shoot | “Large” Shoot | Grain Yield |
|---|---|---|---|---|
| | 28 Days | Number | Number | at Harvest |
| LSD (5%) | 0.41 | 0.33 | 0.25 | 2.11 |
| Treatment | | | | |
| Means | | | | |

A. SOYBEAN—TRIAL 1—Sown on 5 May 2008 in standard potting compost of pH 6.5, in 9 cm pots, thinned to one plant per pot. Sprayed: 18 June, at 2-3 trifoliate leaf stage (V2-V3). Plants were scored/assessed for rooting on 17 July, with other measurements at crop maturity.

| | | | | | | | | Final | |
|---|---|---|---|---|---|---|---|---|---|
| | | | | | | Plant | | Seed | |
| | | | | No of | | Biomass | | Yield | |
| | | Rooting | | Large Pod | | Score | | at | |
| | | (0-9) + | | Bearing | | (0-9) | | Harvest | |
| | | 28 | | Branches/Plant | | at | | (g per | |
| No. | Treatment | Days | + % | at Harvest | + % | Harvest | + % | pot) | + % |
| 1 | Untreated | 4.2 | 0 | 1.0 | 0 | 5.2 | 0 | 33.2 | 0 |
| 2 | AN | 4.3 | 2 | 1.0 | 0 | 5.2 | 0 | 34.8 | 5 |
| 3 | AC | 4.2 | 0 | 1.0 | 0 | 5.2 | 0 | 34.0 | 2 |
| 4 | AN + AC | 4.5 | 7 | 1.0 | 0 | 5.5 | 6 | 35.7 | 8 |
| 5 | Chlormequa | 4.4 | 0 | 1.0 | 0 | 6.0 | 0 | 36.0 | 0 |
| | chloride | | | | | | | | |
| | (620 g/l) - | | | | | | | | |
| | 1.5 l/ha = | | | | | | | | |
| | CCC | | | | | | | | |
| 6 | CCC + AN | 4.6 | 5 | 1.2 | 20 | 6.2 | 3 | 36.7 | 2 |
| 7 | CCC + AC | 4.6 | 5 | 1.2 | 20 | 6.2 | 3 | 36.1 | 0 |
| 8 | CCC + AN + | 4.7 | 7 | 1.4 | 40 | 6.5 | 8 | 37.0 | 3 |
| | AC | | | | | | | | |
| 9 | CCC + AN + | 4.6 | 5 | 1.6 | 60 | 6.5 | 8 | 36.7 | 3 |
| | AC + POL | | | | | | | | |
| 10 | CCC + ADD | 4.6 | 5 | 1.4 | 40 | 6.3 | 5 | 36.6 | 1 |
| 11 | CCC + AN + | 4.8 | 9 | 1.8 | 80 | 6.7 | 12 | 37.9 | 5 |
| | AC + ADD | | | | | | | | |
| 12 | CCC + AN + | 4.6 | 5 | 1.7 | 70 | 6.6 | 10 | 36.8 | 3 |
| | AC + ADD + | | | | | | | | |
| | POL | | | | | | | | |
| 13 | Trinexapac- | 4.4 | 0 | 1.0 | 0 | 6.2 | 0 | 36.2 | 0 |
| | ethyl (250 g/l) - | | | | | | | | |
| | 0.2 l/ha = | | | | | | | | |
| | MOD | | | | | | | | |
| 14 | MOD + AN | 4.4 | 0 | 1.2 | 20 | 6.0 | 0 | 35.8 | 0 |
| 15 | MOD + AC | 4.4 | 0 | 1.2 | 20 | 6.2 | 0 | 36.0 | 0 |
| 16 | MOD + AN + | 4.6 | 5 | 1.4 | 40 | 6.5 | 5 | 37.0 | 3 |
| | AC | | | | | | | | |
| 17 | MOD + AN + | 5.0 | 14 | 1.6 | 60 | 6.7 | 8 | 37.8 | 5 |
| | AC + ADD | | | | | | | | |
| 18 | MOD2 (0.15 l/ha) + | 4.6 | 5 | 1.6 | 60 | 7.0 | 13 | 36.0 | 0 |
| | CCC | | | | | | | | |
| 19 | MOD2 + | 4.8 | 9 | 1.4 | 40 | 7.4 | 23 | 36.0 | 0 |
| | CCC + AN + | | | | | | | | |
| | AC | | | | | | | | |
| 20 | MOD2 + | 5.0 | 14 | 1.8 | 80 | 7.8 | 30 | 38.0 | 6 |
| | CCC + AN + | | | | | | | | |
| | AC + ADD | | | | | | | | |
| 21 | MOD2 + | 4.6 | 5 | 1.5 | 50 | 7.4 | 23 | 36.3 | 0 |
| | CCC + ADD | | | | | | | | |
| 22 | Metconazole | 5.2 | 0 | 1.1 | 0 | 6.0 | 0 | 36.6 | 0 |
| | (60 g/l) - 1.0 l/ha = | | | | | | | | |
| | MET | | | | | | | | |
| 23 | Metconazole | 5.2 | 0 | 1.0 | 0 | 6.0 | 0 | 36.6 | 0 |
| | (60 g/l) - 0.5 l/ha = | | | | | | | | |
| | MET2 | | | | | | | | |
| 24 | MET + AN | 5.4 | 4 | 1.0 | 0 | 6.0 | 0 | 37.0 | 1 |
| 25 | MET2 + AN | 5.4 | 4 | 1.0 | 0 | 6.0 | 0 | 37.1 | 1 |
| 26 | MET + AC | 5.3 | 2 | 1.1 | 0 | 6.0 | 0 | 36.7 | 0 |
| 27 | MET2 + AC | 5.3 | 2 | 1.1 | 10 | 6.0 | 0 | 36.6 | 0 |
| 28 | MET + AN + | 5.6 | 8 | 1.4 | 27 | 6.4 | 7 | 37.5 | 2 |
| | AC | | | | | | | | |
| 29 | MET2 + AN + | 5.6 | 8 | 1.4 | 40 | 6.3 | 5 | 37.4 | 2 |
| | AC | | | | | | | | |
| 30 | MET + AN + | 6.2 | 19 | 1.6 | 45 | 6.8 | 13 | 38.0 | 5 |
| | AC + ADD | | | | | | | | |
| 31 | MET2 + AN + | 6.0 | 15 | 1.6 | 60 | 6.8 | 13 | 38.1 | 5 |
| | AC + ADD | | | | | | | | |
| 32 | MET + ADD | 5.7 | 10 | 1.3 | 18 | 6.3 | 5 | 36.5 | 0 |
| 33 | MET2 + ADD | 5.7 | 10 | 1.3 | 30 | 6.3 | 5 | 36.6 | 0 |

### Experimental Results 2

B. NAVY BEAN—TRIAL 2—cv Primel. Sown on 5 May 2008 in standard potting compost of pH 6.5, in 9 cm pots, thinned to one plant per pot. Sprayed: 23 June, at 2-3 trifoliate leaf stage (V2-V3). Plants were scored/assessed for rooting on 18 July, with other measurements at crop maturity.

| | | | | | | | | Final | |
|---|---|---|---|---|---|---|---|---|---|
| | | | | | | Plant | | Seed | |
| | | | | No of | | Biomass | | Yield | |
| | | Rooting | | Large Pod | | Score | | at | |
| | | (0-9) + | | Bearing | | (0-9) | | Harvest | |
| | | 28 | | Branches/Plant | | at | | (g per | |
| No. | Treatment | Days | + % | at Harvest | + % | Harvest | + % | pot) | + % |
| 1 | Untreated | 7.0 | 0 | 1.0 | 0 | 5.2 | 0 | 48.6 | 0 |
| 2 | AN | 7.2 | 3 | 1.0 | 0 | 5.2 | 0 | 52.0 | 7 |
| 3 | AC | 7.0 | 0 | 1.0 | 0 | 5.2 | 0 | 52.4 | 8 |
| 4 | AN + AC | 7.4 | 6 | 1.2 | 20 | 5.4 | 4 | 54.0 | 11 |
| 5 | Chlomequat | 7.4 | 0 | 1.4 | 0 | 5.4 | 0 | 55.6 | 0 |
| | chloride | | | | | | | | |
| | (620 g/l) - | | | | | | | | |
| | 1.5 l/ha = | | | | | | | | |
| | CCC | | | | | | | | |
| 6 | CCC + AN | 7.6 | 3 | 1.6 | 14 | 5.6 | 4 | 57.0 | 3 |
| 7 | CCC + AC | 7.4 | 0 | 1.4 | 0 | 5.5 | 2 | 57.2 | 3 |
| 8 | CCC + AN + | 7.8 | 5 | 1.7 | 21 | 5.6 | 4 | 57.6 | 4 |
| | AC | | | | | | | | |
| 9 | CCC + AN + | 7.7 | 4 | 1.7 | 21 | 5.6 | 4 | 57.8 | 4 |
| | AC + POL | | | | | | | | |
| 10 | CCC + ADD | 7.6 | 3 | 1.5 | 7 | 5.6 | 4 | 57.0 | 3 |
| 11 | CCC + AN + | 8.0 | 8 | 1.9 | 36 | 5.8 | 7 | 59.0 | 6 |
| | AC + ADD | | | | | | | | |
| 12 | CCC + AN + | 7.8 | 5 | 1.8 | 29 | 5.8 | 7 | 58.8 | 6 |
| | AC + | | | | | | | | |
| | ADD + POL | | | | | | | | |
| 13 | Trinexapac- | 7.2 | 0 | 1.2 | 0 | 5.6 | 0 | 56.1 | 0 |
| | ethyl (250 g/l) - | | | | | | | | |
| | 0.2 l/ha = | | | | | | | | |
| | MOD | | | | | | | | |
| 14 | MOD + AN | 7.4 | 3 | 1.4 | 17 | 5.7 | 2 | 57.2 | 2 |
| 15 | MOD + AC | 7.1 | 0 | 1.2 | 0 | 5.6 | 0 | 56.0 | 0 |
| 16 | MOD + AN + | 7.6 | 6 | 1.7 | 42 | 5.8 | 4 | 58.4 | 4 |
| | AC | | | | | | | | |
| 17 | MOD + AN + | 8.0 | 11 | 2.0 | 67 | 6.0 | 7 | 59.8 | 7 |
| | AC + ADD | | | | | | | | |
| 18 | MOD2 (0.15 l/ha) + | 7.6 | 6 | 1.4 | 17 | 6.0 | 7 | 57.5 | 3 |
| | CCC | | | | | | | | |
| 19 | MOD2 + | 7.8 | 8 | 1.6 | 33 | 6.3 | 13 | 57.4 | 2 |
| | CCC + AN + | | | | | | | | |
| | AC | | | | | | | | |
| 20 | MOD2 + | 8.0 | 11 | 1.9 | 58 | 6.8 | 21 | 58.8 | 5 |
| | CCC + AN + | | | | | | | | |
| | AC + ADD | | | | | | | | |
| 21 | MOD2 + | 7.5 | 4 | 1.6 | 33 | 6.3 | 13 | 57.8 | 2 |
| | CCC + ADD | | | | | | | | |
| 22 | Metconazole | 7.0 | 0 | 1.2 | 0 | 5.2 | 0 | 57.2 | 0 |
| | (60 g/l) - | | | | | | | | |
| | 1.0 l/ha = | | | | | | | | |
| | MET | | | | | | | | |
| 23 | Metconazole | 7.0 | 0 | 1.2 | 0 | 5.1 | 0 | 57.4 | 0 |
| | (60 g/l) - | | | | | | | | |
| | 0.5 l/ha = | | | | | | | | |
| | MET2 | | | | | | | | |
| 24 | MET + AN | 7.3 | 4 | 1.2 | 0 | 5.4 | 4 | 57.6 | 0 |
| 25 | MET2 + AN | 7.2 | 3 | 1.2 | 0 | 5.4 | 4 | 57.8 | 0 |
| 26 | MET + AC | 7.1 | 1 | 1.2 | 0 | 5.2 | 0 | 57.5 | 1 |
| 27 | MET2 + AC | 7.1 | 1 | 1.2 | 0 | 5.2 | 0 | 57.7 | 1 |
| 28 | MET + AN + | 7.5 | 7 | 1.4 | 17 | 5.5 | 6 | 59.1 | 3 |
| | AC | | | | | | | | |
| 29 | MET2 + AN + | 7.5 | 7 | 1.4 | 17 | 5.5 | 6 | 58.9 | 3 |
| | AC | | | | | | | | |
| 30 | MET + AN + | 7.8 | 11 | 1.6 | 33 | 5.8 | 12 | 61.8 | 8 |
| | AC + ADD | | | | | | | | |
| 31 | MET2 + AN + | 7.8 | 11 | 1.6 | 33 | 5.8 | 12 | 59.8 | 5 |
| | AC + ADD | | | | | | | | |
| 32 | MET + ADD | 7.5 | 7 | 1.4 | 17 | 5.5 | 6 | 58.4 | 2 |
| 33 | MET2 + | 7.5 | 7 | 1.4 | 17 | 5.5 | 6 | 58.3 | 2 |
| | ADD | | | | | | | | |

### Experimental Results 3

C. WINTER WHEAT—TRIAL 3—cv Limerick. Sown on 4 May 2008 in standard potting compost of pH 6.5, in 9 cm pots, thinned to eight plants per pot. Sprayed: 10 June, at GS23 (early-mid tillering). Plants were scored/assessed at GS33 on 12 July, with other measurements at crop maturity.

| | | | | | | | | Final | |
|---|---|---|---|---|---|---|---|---|---|
| | | | | Total No | | | | Seed | |
| | | Rooting | | of | | Total No of | | Yield at | |
| | | (0-9) + | | Shoots/ | | “Large” | | Harvest | |
| | | 28 | | Plant at | | Shoots/Plant | | (g per | |
| No. | Treatment | Days | + % | GS33 | + % | at GS33 | + % | pot) | + % |
| 1 | Untreated | 5.4 | 0 | 3.0 | 0 | 2.0 | 0 | 33.6 | 0 |
| 2 | AN | 5.4 | 0 | 3.0 | 0 | 2.0 | 0 | 33.6 | 0 |
| 3 | AC | 5.4 | 0 | 3.0 | 0 | 2.0 | 0 | 33.9 | 0 |
| 4 | AN + AC | 5.6 | 4 | 3.3 | 10 | 2.2 | 10 | 35.4 | 5 |
| 5 | Chlomequat | 6.0 | 0 | 3.8 | 0 | 2.6 | 0 | 36.4 | 0 |
| | chloride | | | | | | | | |
| | (620 g/l) - | | | | | | | | |
| | 1.5 l/ha = | | | | | | | | |
| | CCC | | | | | | | | |
| 6 | CCC + AN | 6.1 | 2 | 4.0 | 5 | 2.8 | 8 | 35.8 | 0 |
| 7 | CCC + AC | 6.0 | 0 | 4.0 | 5 | 2.8 | 8 | 35.8 | 0 |
| 8 | CCC + AN + | 6.4 | 7 | 4.4 | 16 | 3.0 | 7 | 35.2 | 0 |
| | AC | | | | | | | | |
| 9 | CCC + AN + | 6.4 | 7 | 4.6 | 21 | 3.2 | 23 | 35.6 | 0 |
| | AC + POL | | | | | | | | |
| 10 | CCC + ADD | 6.4 | 7 | 4.0 | 5 | 2.9 | 4 | 34.4 | 0 |
| 11 | CCC + AN + | 7.0 | 17 | 5.2 | 37 | 3.6 | 38 | 36.3 | 0 |
| | AC + ADD | | | | | | | | |
| 12 | CCC + AN + | 7.0 | 17 | 5.2 | 37 | 3.6 | 38 | 36.4 | 0 |
| | AC + | | | | | | | | |
| | ADD + POL | | | | | | | | |
| 13 | Trinexapac- | 6.4 | 0 | 3.8 | 0 | 2.6 | 0 | 35.4 | 0 |
| | ethyl (250 g/l) - | | | | | | | | |
| | 0.2 l/ha = | | | | | | | | |
| | MOD | | | | | | | | |
| 14 | MOD + AN | 6.4 | 0 | 3.9 | 3 | 2.8 | 8 | 34.4 | 0 |
| 15 | MOD + AC | 6.3 | 0 | 3.8 | 0 | 2.6 | 0 | 34.0 | 0 |
| 16 | MOD + AN + | 6.7 | 5 | 4.0 | 5 | 2.8 | 8 | 35.6 | 0 |
| | AC | | | | | | | | |
| 17 | MOD + AN + | 7.2 | 13 | 4.6 | 21 | 3.2 | 23 | 36.2 | 2 |
| | AC + ADD | | | | | | | | |
| 18 | MOD2 (0.15 l/ha) + | 6.8 | 6 | 4.4 | 16 | 3.0 | 15 | 37.2 | 5 |
| | CCC | | | | | | | | |
| 19 | MOD2 + | 6.8 | 6 | 4.7 | 24 | 3.3 | 27 | 36.6 | 3 |
| | CCC + AN + | | | | | | | | |
| | AC | | | | | | | | |
| 20 | MOD2 + | 7.4 | 16 | 5.5 | 45 | 3.8 | 46 | 35.6 | 0 |
| | CCC + AN + | | | | | | | | |
| | AC + ADD | | | | | | | | |
| 21 | MOD2 + | 6.7 | 5 | 3.9 | 3 | 2.8 | 8 | 35.5 | 0 |
| | CCC + ADD | | | | | | | | |
| 22 | Metconazole | 6.0 | 0 | 3.8 | 0 | 2.6 | 0 | 36.2 | 0 |
| | (60 g/l) - 1.0 l/ha = | | | | | | | | |
| | MET | | | | | | | | |
| 23 | Metconazole | 6.0 | 0 | 3.8 | 0 | 2.6 | 0 | 36.0 | 0 |
| | (60 g/l) - 0.5 l/ha = | | | | | | | | |
| | MET2 | | | | | | | | |
| 24 | MET + AN | 6.2 | 3 | 4.4 | 16 | 3.0 | 15 | 36.2 | 0 |
| 25 | MET2 + AN | 6.2 | 3 | 4.4 | 16 | 3.0 | 15 | 36.1 | 0 |
| 26 | MET + AC | 6.0 | 0 | 4.1 | 8 | 2.8 | 8 | 36.2 | 0 |
| 27 | MET2 + AC | 6.0 | 0 | 4.1 | 8 | 2.8 | 8 | 36.5 | 1 |
| 28 | MET + AN + | 6.6 | 10 | 4.6 | 21 | 3.2 | 23 | 37.8 | 4 |
| | AC | | | | | | | | |
| 29 | MET2 + AN + | 6.6 | 10 | 4.6 | 21 | 3.2 | 23 | 37.2 | 4 |
| | AC | | | | | | | | |
| 30 | MET + AN + | 7.2 | 20 | 5.2 | 37 | 3.6 | 38 | 38.6 | 7 |
| | AC + ADD | | | | | | | | |
| 31 | MET2 + AN + | 7.4 | 23 | 5.2 | 37 | 3.6 | 38 | 38.5 | 7 |
| | AC + ADD | | | | | | | | |
| 32 | MET + ADD | 6.3 | 5 | 4.6 | 21 | 3.1 | 19 | 36.3 | 0 |
| 33 | MET2 + ADD | 6.3 | 5 | 4.5 | 18 | 3.1 | 19 | 36.1 | 0 |

### Experimental Results 4

D. WINTER WHEAT TRIAL 4—Field trial, sown 18 Oct. 2007. Mean of Nine Varieties—mean values from varieties Solstice, Battalion, Duxford, Marksman, Gallant, Panorama, Qplus, Cassius, Alchemy. Location: Great Dunmow, Essex, UK, 2008. Seed rate 400 seeds/sq metre. Formulations applied mid-tillering (GS23), and assessed at GS33 and at maturity.

| | | | | | | | | Final |
|---|---|---|---|---|---|---|---|---|
| | | | | Mean | Mean | Mean | | Ear |
| | | Total | No of | Root | Root | Root | | Wt |
| | | Stem | “large” | Diameter | Length | Weight | Mean % | (10 |
| | | Number | Stems | GS33 | GS33 | GS33 | Lodged | ears) |
| No | Treatment | GS33 | GS33 | (cm) | (cm) | (g) | Maturity | (g) |
| 1 | Untreated | 3.61 | 2.50 | 2.16 | 2.00 | 3.18 | 8.9 | 17.9 |
| 2 | AN + AC | 4.33 | 3.06 | 2.68 | 2.74 | 4.73 | 1.7 | 18.3 |
| 3 | CCC (1.0 l/ha) | 4.40 | 2.95 | 2.51 | 2.40 | 4.10 | 1.7 | 18.4 |
| 4 | CCC (1.0) + | 4.58 | 3.17 | 2.52 | 2.48 | 4.28 | 1.7 | 18.5 |
| | ADD | | | | | | | |
| 5 | AN + AC + | 4.56 | 3.19 | 2.75 | 2.80 | 4.93 | 1.7 | 18.6 |
| | ADD | | | | | | | |
| 6 | CCC + | 5.19 | 3.67 | 3.19 | 3.27 | 9.35 | 0.0 | 19.7 |
| | AN + AC + | | | | | | | |
| | ADD | | | | | | | |

| | | | | | | | |
|---|---|---|---|---|---|---|---|
| LSD (5%) | 0.33 | 0.28 | 0.22 | 0.26 | 1.41 | 5.00 | 1.62 |
| Treatment | | | | | | | |
| Means | | | | | | | |

### Experimental Results 5

E. WINTER BARLEY TRIAL 5—Field trial, sown 14 Oct. 2007. Mean of Nine Varieties—mean values from varieties Pearl, Flagon, Cassata, Wintmalt, Saffron, Suzuka, Marcorel, Sequel, Volume. Location: Great Dunmow, Essex, UK, 2008. Seed rate 400 seeds/sq metre. Formulations applied mid-tillering (GS23), and assessed at GS33 and at maturity.

| | | | | | | | | Final |
|---|---|---|---|---|---|---|---|---|
| | | | | Mean | Mean | Mean | | Ear |
| | | Total | No of | Root | Root | Root | | Wt |
| | | Stem | “large” | Diameter | Length | Weight | Mean % | (10 |
| | | Number | Stems | GS33 | GS33 | GS33 | Lodged | ears) |
| No | Treatment | GS33 | GS33 | (cm) | (cm) | (g) | Maturity | (g) |
| 1 | Untreated | 5.08 | 3.50 | 1.72 | 3.18 | 2.09 | 23.9 | 21.7 |
| 2 | AN + AC | 5.89 | 4.17 | 2.26 | 3.82 | 3.51 | 26.7 | 22.3 |
| 3 | CCC (1.0 l/ha) | 6.01 | 4.23 | 2.05 | 3.66 | 3.06 | 26.3 | 22.8 |
| 4 | CCC + ADD | 6.25 | 4.41 | 2.19 | 3.75 | 3.11 | 26.1 | 22.9 |
| 5 | AN + AC + | 6.42 | 4.46 | 2.52 | 4.06 | 4.11 | 25.0 | 23.1 |
| | ADD | | | | | | | |
| 6 | CCC + AN + | 7.25 | 4.97 | 3.13 | 4.87 | 8.20 | 15.0 | 24.5 |
| | AC + ADD | | | | | | | |

| | | | | | | | |
|---|---|---|---|---|---|---|---|
| LSD (5%) | 0.36 | 0.31 | 0.21 | 0.27 | 1.52 | 7.12 | 2.12 |
| Treatment | | | | | | | |
| Means | | | | | | | |

The following results demonstrate the synergistic benefits from the application of growth regulator combinations:

### Experimental Results 6

F. WINTER WHEAT VARIETIES—UK field trials. Formulations applied at mid-tillering and measured at third node stage (GS33).

Treatments compared:
A. Control vs
B. Chlormequat chloride (620 g/litre) applied at 1.0 litre in 250 litres water per hectare.
C. Anthranilic Acid (1 g/ha)+Acetaminophen (3 g/ha) in 250 litres water per hectare.
B.+C. Combination of B. and C. above, in 250 litres water per hectare.

Mean Root Weight Per Plant (g)—three winter wheat varieties: individual replicates and mean values. Mean root weight per plant (g) is a mean value from 10 median plants taken from a representative 20 plant sample per plot.

| VARIETY | A. | B. | C. | B + C |
|---|---|---|---|---|
| Solstice | 2.6 | 3.6 | 3.9 | 8.0 |
| Solstice | 2.8 | 3.7 | 3.8 | 7.9 |
| Solstice | 2.8 | 3.8 | 4.0 | 8.1 |
| Solstice | 2.9 | 3.6 | 4.0 | 8.0 |
| Mean | 2.78 | 3.68 | 3.93 | 8.00 |
| Increase | — | +0.9 g | +1.15 g | +5.22 g |
| Battalion | 3.0 | 4.4 | 4.4 | 9.0 |
| Battalion | 3.0 | 4.2 | 4.5 | 9.2 |
| Battalion | 3.5 | 4.1 | 4.6 | 9.0 |
| Battalion | 3.0 | 4.3 | 4.3 | 9.3 |
| Mean | 3.13 | 4.25 | 4.45 | 9.13 |
| Increase | — | +1.12 g | +1.32 g | +6.00 g |
| Marksman | 3.4 | 4.3 | 5.5 | 10.0 |
| Marksman | 3.3 | 4.4 | 5.6 | 11.0 |
| Marksman | 3.2 | 4.5 | 5.5 | 11.5 |
| Marksman | 3.3 | 4.4 | 5.4 | 12.0 |
| Mean | 3.30 | 4.40 | 5.50 | 11.13 |
| Increase | — | +1.10 g | +2.20 g | +7.83 g |

### Experimental Results 7

G. WINTER BARLEY VARIETIES—UK field trials. Formulations applied at mid-tillering and measured at third node stage (GS33).

Treatments compared:
A. Control vs
B. Chlormequat chloride (620 g/litre) applied at 1.0 litre in 250 litres water per hectare.
C. Anthranilic Acid (1 g/ha)+Acetaminophen (3 g/ha) in 250 litres water per hectare.
B.+C. Combination of B. and C. above, in 250 litres water per hectare.

Mean Root Weight Per Plant (g)—three winter barley varieties: individual replicates and mean values.

| VARIETY | A. | B. | C. | B + C |
|---|---|---|---|---|
| Flagon | 2.3 | 4.0 | 4.5 | 11.0 |
| Flagon | 2.3 | 4.0 | 4.6 | 11.1 |
| Flagon | 2.5 | 3.9 | 4.5 | 10.8 |
| Flagon | 2.4 | 4.2 | 4.5 | 10.8 |
| Mean | 2.38 | 4.03 | 4.53 | 10.93 |
| Increase | — | +1.65 g | +2.15 g | +8.55 g |
| Suzuka | 2.0 | 3.0 | 5.0 | 8.0 |
| Suzuka | 2.0 | 3.0 | 5.0 | 8.6 |
| Suzuka | 3.0 | 4.0 | 4.0 | 8.0 |
| Suzuka | 2.4 | 3.0 | 5.0 | 8.7 |
| Mean | 2.35 | 3.25 | 4.75 | 8.33 |
| Increase | — | +0.90 g | +2.50 g | +5.98 g |
| Marcorel | 2.0 | 2.8 | 3.2 | 7.0 |
| Marcorel | 2.0 | 2.8 | 3.1 | 7.0 |
| Marcorel | 1.9 | 2.9 | 3.1 | 7.6 |
| Marcorel | 2.0 | 2.8 | 3.1 | 7.8 |
| Mean | 1.98 | 2.83 | 3.13 | 7.35 |
| Increase | — | +0.85 g | +1.15 g | +5.37 g |

All publications mentioned in the above specification are herein incorporated by reference. Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the field are intended to be within the scope of the following claims.

1-26. (canceled)

27. A composition comprising anthranilic acid or a derivative thereof and an agrochemically acceptable additive comprising at least one compound selected from:
a) glucose, hydrolysed starch, sucrose, fructose, glycerol, glyceraldehydes, erythrose, ribulose, xylulose or arabinose, monosaccharides including aldoses such as D-ribose, D-xylose, L-arabinose, D-glucose, D-mannose and D-galactose; ketoses such as D-ribulose and D-fructose; deoxyaldoses such as 2-Deoxy-D-ribose, L-fucose; acetylated amino sugars such as N-acteyl-D-glucosamine and N-acetyl-D-galactosamine; acidic monosaccharides such as D-glucuronic acid, L-iduronic acid and N-acetylneuraminic acid, sugar alcohols such as D-sorbitol and D-mannitol, disaccharides including maltose, lactose and sucrose, or an ester or glycoside or metabolic equivalent of such a carbohydrate;
b) an organic acid of the Krebs tricarboxylic acid cycle or a metabolic precursor thereof;
c) a vitamin or coenzyme, or a precursor thereof;
d) a purine or pyrimidine nucleoside, nucleotide or metabolic precursor thereof;
e) a naturally occurring fat or oil; or
f) an amino acid,
for use to improve the efficacy of a plant growth regulator.

28. The composition of claim 27 wherein the agrochemically acceptable additive comprises at least one compound selected from c) a vitamin or coenzyme, or a precursor thereof; d) a purine or pyrimidine nucleoside, nucleotide or metabolic precursor thereof; or f) an amino acid.

29. The composition according to claim 27 wherein the anthranilic derivative is a conjugate, a salt, an ester, or an amide of the acid, optionally substituted with an alkyl or halogen group.

30. The composition according to claim 29 wherein the compound is conjugated to a sugar, an alcohol, an amino acid, a peptide or a protein.

31. The composition according to claim 27 further comprising acetaminophen or a derivative thereof; preferably acetaminophen.

32. The composition of claim 27 further comprising a plant growth regulator.

33. A composition according to claim 32 wherein the plant growth regulator is selected from an auxin, an auxin precursor, an auxin metabolite or a derivative of said auxin, auxin precursor or auxin metabolite with the proviso that the plant growth regulator is not an anthranilic acid or derivative thereof as defined in claim 1.

34. The composition according to claim 33 wherein the auxin is an indolic auxin or a phenolic auxin.

35. The composition according to claim 33 wherein the derivative is an acid, a conjugate, a salt, an ester, or an amide of the auxin, or an alkylated or halogenated auxin.

36. The composition according to claim 35 wherein the auxin is conjugated to a sugar, an alcohol, an amino acid, a peptide or a protein.

37. The composition according to claim 33 wherein the precursor is chorismate, phosphoribosyl anthraniliate, 1-(O-carboxyphenulamino)-1-deoxyribulose-5-phosphate, indole-3-glycerol-phosphate, indole, indole-3-acetic acid, tryptophan, tryptamine, N-hydroxy tryptamine, indole-3-acetaldoxime, 1-aci-nitro-2-indolylethane, indolic glucosinate, indole-3-acetonitrile (IAN), indole-3-acetaldehyde, indole-3-lactic acid, indole-3-pyruvic acid, or indole-3-ethanol.

38. The composition according to claim 27 wherein the auxin is a natural auxin selected from indole-3-acetic acid (IAA), 4-chloro-indole-3-acetic acid (4-Cl-IAA), phenylacetic acid (PAA), indole-3-butyric acid (IBA), indole-3-acetyl-1-O-β-D-glucose (IAAglc); or a synthetic auxin selected from 1-naphthaleneacetic acid (NAA), 2,4-dichlorophenoxyacetic acid (2,4-D), 2-methoxy-3,6-dichlorobenzoic acid (dicamba), 4-amino-3,5,6-trichloropicolinic acid (tordon), 2,4,5-trichlorophenoxyacetic acid (2,4,5-T), 2,3,6-trichlorobenzoic acid, 4-chloro-2 methyl phenoxy acetic acid (MCPA) or N,N-dimethylethylthiocarbamate.

39. The composition according to claim 38 wherein the conjugate of the natural auxin is IAA-Inositol, IAA-Inositol-arabinose, IAP1, an IAA-peptide, an IAA glycoprotein, an IAA-glucan, IAA-aspartate, IAA-glucose, IAA-1-O-glucose, IAA-myo-Inositol, IAA-4-O-glucose, IAA-6-O-glucose, IAA-Inositol-galactose, an IAA amide conjugate, or an IAA-amino acid conjugate.

40. The composition according to claim 33 wherein the metabolite is indole-3-lactic acid or indole-3-ethanol.

41. A composition according to claim 32 wherein the plant growth regulator is abscisic acid or a derivative thereof, a cytokinin, ethylene or a gibberlin.

42. A composition according to claim 32 wherein the plant growth regulator is p-Chlorophenoxyacetic acid (4-CPA), 2-CPA, 2,4-Dichlorophenoxyacetic acid, 2,4-Dichlorophenoxyacetic acid Sodium salt, Indole-3-acetic acid Free acid (IAA), Indole-3-acetic acid Sodium salt, Indole-3-acetic acid methyl ester, Indole-3-acety-L-aspartic acid, Indole-3-butyric acid (IBA), Indole-3-butyric acid Potassium salt (K-IBA), alpha-Naphthaleneacetic acid Free acid (NAA), beta-Naphthoxyacetic acid Free acid (NOA), Phenylacetic acid (PAA), Picloram, 2,4,5-Trichlorophenoxyacetic acid (2,4,5-T), 2,3,5-Triiodobenzoic acid Free acid (TIBA), Adenine Free base, Adenine hemisulfate salt, 6-Benzylaminopurine (BA), 6-Benzylaminopurine Hydrochloride, N-Benzyl-9-(2-tetrahydropyranyl) adenine (BPA), N-(2-Chloro-4-pyridyl)N′-phenylurea (4-CPPU), 6-(gamma, gamma-Dimethylallylamino)purine (2iP), 1,3-Diphenylurea (DPU), Kinetin, Kinetin Hydrochloride, 1-Phenyl-3-(1,2,3-thiadiazol-5-yl) urea, trans-Zeatin Free base, Zeatin, trans-Zeatin Hydrochloride, trans-Zeatin riboside, (±)-cis,trans-Abscisic acid (ABA), Ancymidol, Chlorocholine chloride (CCC), chlormequat chloride+choline chloride (5C chlormequat), 3,6-Dichloro-o-anisic acid (Dicamba), Gibberellic acid (GA₃), Gibberellic acid Potassium salt (K-GA₃), Gibberellin A₄ Free acid (GA₄), (±)-jasmonic acid, Phloroglucinol, N-(Phosphonomethyl)glycine (Glyphosate), Succinic acid 2,2-dimethylhydrazide, trinexapacethyl or metconazole.

43. The composition according to claim 32 wherein the plant growth regulator is selected from antiauxins, such as: clofibric acid and 2,3,5-tri-iodobenzoic acid; auxins such as 4-CPA, 2,4-D, 2,4-DB, 2,4-DEP, dichlorprop, fenoprop, IAA, IBA, naphthaleneacetamide, α-naphthaleneacetic acid, 1-naphthol, naphthoxyacetic acid, potassium naphthenate, sodium naphthenate, 2,4,5-T; cytokinins such as 2iP, benzyladenine, kinetin, zeatin; defoliants such as calcium cyanamide, dimethipin, endothal, ethephon, merphos, metoxuron, pentachlorophenol, thidiazuron, tribufos; ethylene inhibitors such as aviglycine, 1-methylcyclopropene; ethylene releasers such as ACC, etacelasil, ethephon, glyoxime; gibberellins such as gibberellins, gibberellic acid; growth inhibitors such as abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, mepiquat chloride, piproctanyl, prohydrojasmon, propham, 2,3,5-tri-iodobenzoic acid; morphactins such as chlorfluren, chlorflurenol, dichlorflurenol, flurenol; growth retardants such as chlormequat, daminozide, flurprimidol, mefluidide, paclobutrazol tetcyclacis, uniconazole; growth stimulators such as brassinolide, forchlorfenuron, hymexazol; and unclassified plant growth regulators such as benzofluor, buminafos, carvone, ciobutide, clofencet, cloxyfonac, cyanamide, cyclanilide, cycloheximide, cyprosulfamide, epocholeone, ethychlozate, ethylene, fenridazon, heptopargil, holosulf, inabenfide, karetazan, lead arsenate, methasulfocarb, prohexadione, pydanon, sintofen, triapenthenol, trinexapac.

44. A composition of claim 27 wherein the composition further comprises an adjuvant.

45. A method of improving the efficacy of a plant growth regulator comprising applying the composition of claim 27 to a plant growth regulator.

46. A method of regulating plant growth comprising applying the composition of claim 27 to a plant or its environs.
